(19) United States
(12) Patent Application Publication
(10) Pub. No.: US 2026/0247103 A1
(43) Pub. Date: Aug. 20, 2026

(54) MOTION-TRIGGERED WAYPOINT REPORTING

(71) Applicant: QUALCOMM Incorporated, San Diego, CA (US)

(72) Inventors: Bala RAMASAMY, San Marcos, CA (US); Alexandros MANOLAKOS, Athens (GR); Harleen GILL, Los Altos, CA (US); Guruprasad Prabhakar CHINNABHANDAR, San Diego, CA (US)

(21) Appl. No.: 18/872,259

(22) PCT Filed: Jun. 26, 2023
(86) PCT No.: PCT/US2023/026196

§ 371 Date: Dec. 5, 2024

(30) Foreign Application Priority Data
Jul. 19, 2022 (GR) 20220100570

(51) Int. Cl. H04W 4/02; H04L 9/08

(52) U.S. Cl. CPC H04W 4/027; H04L 9/0825

(57) ABSTRACT

Aspects presented herein relate to methods and devices for wireless communication including an apparatus, e.g., a device or a server. The apparatus may obtain, along a route of the device, at least one of motion information of the device or environmental information associated with the device. Additionally, the apparatus may transmit, when the obtained information is inconsistent with at least one of an expected motion pattern of the device or an expected environmental pattern of the device along the route, information indicating that the obtained at least one of the motion information or the environmental information is inconsistent with the at least one of the expected motion pattern of the device or the expected environmental pattern of the device along the route.

### CROSS-REFERENCE TO RELATED APPLICATION

This application claims the benefit of Greece Patent Application Serial No. 20220100570, entitled “MOTION-TRIGGERED WAYPOINT REPORTING” and filed on Jul. 19, 2022, which is expressly incorporated by reference herein in its entirety.

### TECHNICAL FIELD

The present disclosure relates generally to communication systems, and more particularly, to positioning measurements in wireless communication systems.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be an apparatus for wireless communication at a device or a user equipment (UE). The apparatus may generate at least one of an expected motion pattern of a device or an expected environmental pattern of the device for a route based on at least one of motion information of one or more other devices or environmental information associated with the one or more other devices. The apparatus may also obtain, along a route of the device, at least one of motion information of the device or environmental information associated with the device. Further, the apparatus may obtain, along the route of the device, at least one of motion information of one or more other devices or environmental information associated with the one or more other devices. The apparatus may also determine, based on a comparison of the obtained information with the at least one of the expected motion pattern of the device or the expected environmental pattern of the device along the route, that the obtained information is inconsistent with the at least one of the expected motion pattern of the device or the expected environmental pattern of the device along the route. The apparatus may also transmit, when the obtained information is inconsistent with at least one of an expected motion pattern of the device or an expected environmental pattern of the device along the route, information indicating that the obtained at least one of the motion information or the environmental information is inconsistent with the at least one of the expected motion pattern of the device or the expected environmental pattern of the device along the route. Moreover, the apparatus may transmit, when the obtained information is consistent with at least one of the expected motion pattern of the device or the expected environmental pattern of the device along the route, second information indicating that the obtained at least one of the motion information or the environmental information corresponds with the at least one of the expected motion pattern of the device or the expected environmental pattern of the device along the route. The apparatus may also obtain, upon the determination that the obtained information is inconsistent with the at least one of the expected motion pattern of the device or the expected environmental pattern of the device along the route, at least one of route deviation information of the device, absolute or relative position information of the device, device information associated with at least one of a detected access point, a detected base station, or a detected wireless device, or any combination thereof, where the transmitted information indicates the at least one of the route deviation information of the device, the absolute or relative position information of the device, the device information associated with the at least one of the detected access point, the detected base station, or the detected wireless device, or any combination thereof. The apparatus may also initiate a wake-up state of the device when the obtained at least one of the motion information or the environmental information is consistent with the at least one of the expected motion pattern of the device or the expected environmental pattern of the device along the route; and transmit, during the wake-up state of the device, an indication of at least one of: (1) one or more access points, one or more base stations, or one or more wireless devices along the route, or (2) the device passed one or more predefined locations along the route.

In an aspect of the disclosure, a method, a computer-readable medium, and an apparatus are provided. The apparatus may be an apparatus for wireless communication at a server or a network entity. The apparatus may generate at least one of an expected motion pattern or an expected environmental pattern along a route based on received crowdsourced information indicating at least one of motion pattern or environmental pattern along the route. The apparatus may also configure a device with at least one of an expected motion pattern of the device or an expected environmental pattern of the device along a route. Additionally, the apparatus may configure the device with at least one of a public key associated with the server or a private key, where the received information is encrypted based on at least one of the public key or the private key. The apparatus may also receive, based on the configuration, information from the device indicating that at least one of motion information at the device or environmental information associated with the device is inconsistent with the configured at least one of the expected motion pattern of the device or the expected environmental pattern of the device along the route. Moreover, the apparatus may determine, based on the received information from the device, at least one of the device has been compromised or stolen based on the received at least one of the motion information or the environmental information. The apparatus may also modify the at least one of the expected motion pattern or the expected environmental pattern along the route based on machine learning and received second information indicating the at least one of the motion pattern or the environmental pattern experienced by additional devices along the route.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of a wireless communication system.

FIG. 6 is a diagram illustrating an example positioning procedure.

FIG. 7 is a diagram illustrating an example route for a device in a wireless communication system.

FIG. 8 is a diagram illustrating an example route for a device in a wireless communication system.

FIG. 9 is a diagram illustrating an example route for a device in a wireless communication system.

FIG. 10 is a diagram illustrating an example route for a device in a wireless communication system.

FIG. 11 is a diagram illustrating an example route for a device in a wireless communication system.

FIG. 12 is a communication flow diagram illustrating example communications between a device and a server.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a diagram illustrating an example of a hardware implementation for an example apparatus and/or network entity.

FIG. 20 is a diagram illustrating an example of a hardware implementation for an example network entity.

FIG. 21 is a diagram illustrating an example of a hardware implementation for an example network entity.

### DETAILED DESCRIPTION

Aspects of wireless communication may utilize a number of different routes or areas during a position location process for a device (e.g., an Internet of Things (IoT) device). For instance, a position location process may utilize a perimeter or a geofence (i.e., a virtual perimeter around a real-world geographic area) to assist in determining a location of a device. In some aspects, position location processes utilizing geofences may specify a mobile device to actively measure the location of the device. This active measurement by the device may be utilized to determine whether the device is within the designated area of a geofence, or to determine whether the device has breached the designated area of the geofence. However, active measurement may cause excessive power consumption at the device, such that any benefit in accuracy and latency may not be worthwhile. For instance, the frequency of any active measurement may result in a tradeoff between accuracy/latency of positioning within the geofence in favor of power consumption at the device. In some instances, a position location system may indicate for a device to reduce a duty cycle of an active measurement by a certain amount (e.g., reduce the duty cycle by 25%). However, this reduction in duty cycle may result in a loss of accuracy/latency, but not result in a corresponding benefit in reduced power consumption at the device. Accordingly, any power savings for reducing the duty cycle of active measurement may not be sufficiently beneficial to the device. Based on the above, it may be beneficial to favor the power consumption at a device over the accuracy/frequency of reporting whether the device is within a geofence (or the geofence has been breached). For example, when tracking a remote shipment, if a shipment deviates from a geofence, the latency of when the breach occurred may not be sufficiently beneficial compared to reporting the breach within a certain time period (e.g., within a threshold number of minutes). Aspects of the present disclosure may improve the power consumption of devices in position location systems. For instance, aspects presented herein may prioritize the power consumption at a device over the accuracy/frequency of reporting whether the device is within a certain range (e.g., a geofence). In some instances, aspects presented herein may take a system-level approach to reducing power consumption at a device. For example, aspects of the present disclosure may consider the overall position location system for devices within geofences in order to reduce the power consumption at a specific device. Additionally, devices herein may obtain motion data or environmental data associated with a device along a certain route. Devices herein may determine whether the obtained data is inconsistent with preconfigured/expected motion data or preconfigured/expected environmental data. Further, aspects presented herein may notify a server/network in a position location system when the obtained data is inconsistent with preconfigured/expected motion data or preconfigured/expected environmental data.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

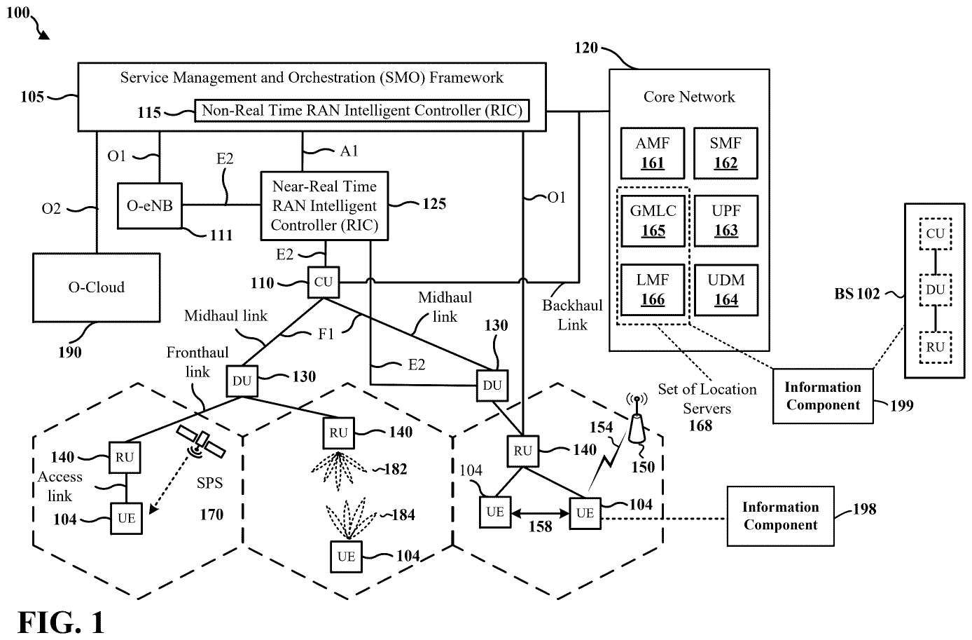

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network. In some scenarios, the term UE may also apply to one or more companion devices such as in a device constellation arrangement. One or more of these devices may collectively access the network and/or individually access the network. A network node can be implemented as a base station (i.e., an aggregated base station), as a disaggregated base station, an integrated access and backhaul (IAB) node, a relay node, a sidelink node, etc. A network entity can be implemented as a base station (i.e., an aggregated base station), or alternatively, as a central unit (CU), a distributed unit (DU), a radio unit (RU), a Near-Real Time (Near-RT) RAN Intelligent Controller (RIC), or a Non-Real Time (Non-RT) RIC in a disaggregated base station architecture.

Referring again to FIG. 1, in certain aspects, the UE 104 may include an information component 198 that may be configured to generate at least one of an expected motion pattern of a device or an expected environmental pattern of the device for a route based on at least one of motion information of one or more other devices or environmental information associated with the one or more other devices, where a determination that obtained information is inconsistent with at least one of an expected motion pattern of the device or an expected environmental pattern of the device along the route is based on at least one of motion information of the device or environmental information associated with the device deviating by a threshold from at least one of the motion information of the one or more other devices or the environmental information associated with the one or more other devices. Information component 198 may also be configured to obtain, along a route of the device, at least one of motion information of the device or environmental information associated with the device. Information component 198 may also be configured to obtain, along the route of the device, at least one of motion information of one or more other devices or environmental information associated with the one or more other devices, where a determination that the obtained information is inconsistent with the at least one of the expected motion pattern of the device or the expected environmental pattern of the device along the route is further based on a comparison between the at least one of the motion information of the device or the environmental information associated with the device and the at least one of the motion information of the one or more other devices or the environmental information associated with the one or more other devices. Information component 198 may also be configured to determine, based on a comparison of the obtained information with the at least one of the expected motion pattern of the device or the expected environmental pattern of the device along the route, that the obtained information is inconsistent with the at least one of the expected motion pattern of the device or the expected environmental pattern of the device along the route. Information component 198 may also be configured to transmit, when the obtained information is inconsistent with at least one of an expected motion pattern of the device or an expected environmental pattern of the device along the route, information indicating that the obtained at least one of the motion information or the environmental information is inconsistent with the at least one of the expected motion pattern of the device or the expected environmental pattern of the device along the route. Information component 198 may also be configured to transmit, when the obtained information is consistent with at least one of the expected motion pattern of the device or the expected environmental pattern of the device along the route, second information indicating that the obtained at least one of the motion information or the environmental information corresponds with the at least one of the expected motion pattern of the device or the expected environmental pattern of the device along the route. Information component 198 may also be configured to obtain, upon the determination that the obtained information is inconsistent with the at least one of the expected motion pattern of the device or the expected environmental pattern of the device along the route, at least one of route deviation information of the device, absolute or relative position information of the device, device information associated with at least one of a detected access point, a detected base station, or a detected wireless device, or any combination thereof, where the transmitted information indicates the at least one of the route deviation information of the device, the absolute or relative position information of the device, the device information associated with the at least one of the detected access point, the detected base station, or the detected wireless device, or any combination thereof. Information component 198 may also be configured to initiate a wake-up state of the device when the obtained at least one of the motion information or the environmental information is consistent with the at least one of the expected motion pattern of the device or the expected environmental pattern of the device along the route; and transmit, during the wake-up state of the device, an indication of at least one of: (1) one or more access points, one or more base stations, or one or more wireless devices along the route, or (2) the device passed one or more predefined locations along the route.

In certain aspects, the base station 102 and/or LMF 166 may include an information component 199 that may be configured to generate at least one of an expected motion pattern or an expected environmental pattern along a route based on received crowdsourced information indicating at least one of motion pattern or environmental pattern along the route. Information component 199 may also be configured to configure a device with at least one of an expected motion pattern of the device or an expected environmental pattern of the device along a route. Information component 199 may also be configured to configure the device with at least one of a public key associated with the server or a private key, where the received information is encrypted based on at least one of the public key or the private key. Information component 199 may also be configured to receive, based on the configuration, information from the device indicating that at least one of motion information at the device or environmental information associated with the device is inconsistent with the configured at least one of the expected motion pattern of the device or the expected environmental pattern of the device along the route. Information component 199 may also be configured to determine, based on the received information from the device, at least one of the device has been compromised or stolen based on the received at least one of the motion information or the environmental information. Information component 199 may also be configured to modify the at least one of the expected motion pattern or the expected environmental pattern along the route based on machine learning and received second information indicating the at least one of the motion pattern or the environmental pattern experienced by additional devices along the route. Although the following description may be focused on 5G NR, the concepts described herein may be applicable to other similar areas, such as LTE, LTE-A, CDMA, GSM, and other wireless technologies.

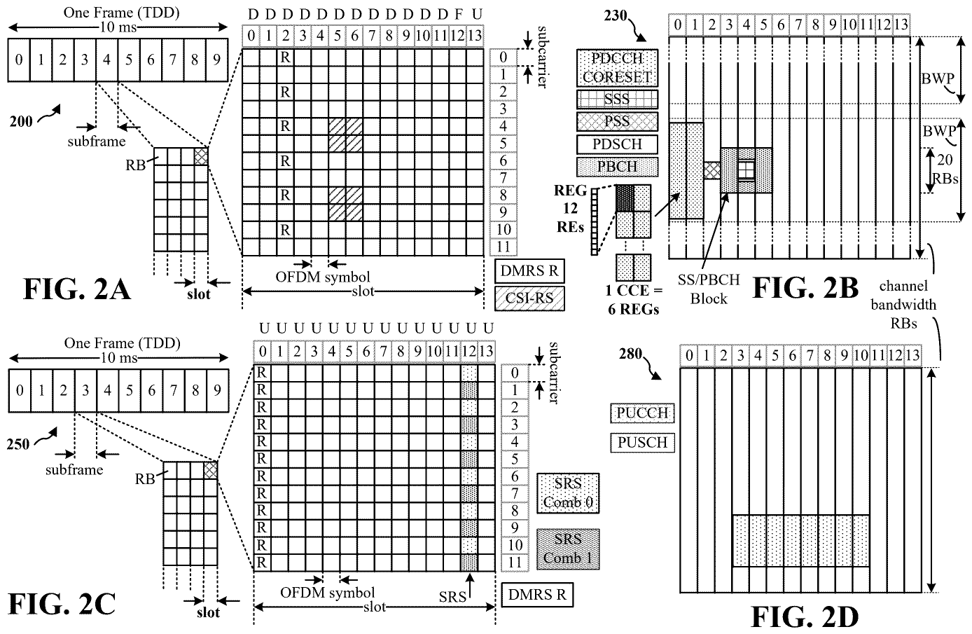

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

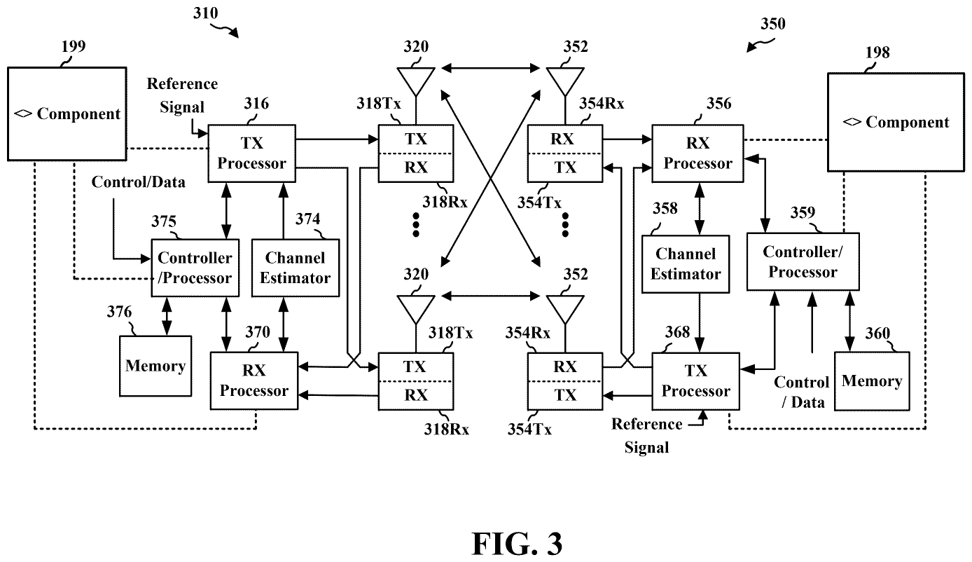

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the information component 198 of FIG. 1. At least one of the TX processor 316, the RX processor 370, and the controller/processor 375 may be configured to perform aspects in connection with the information component 199 of FIG. 1.

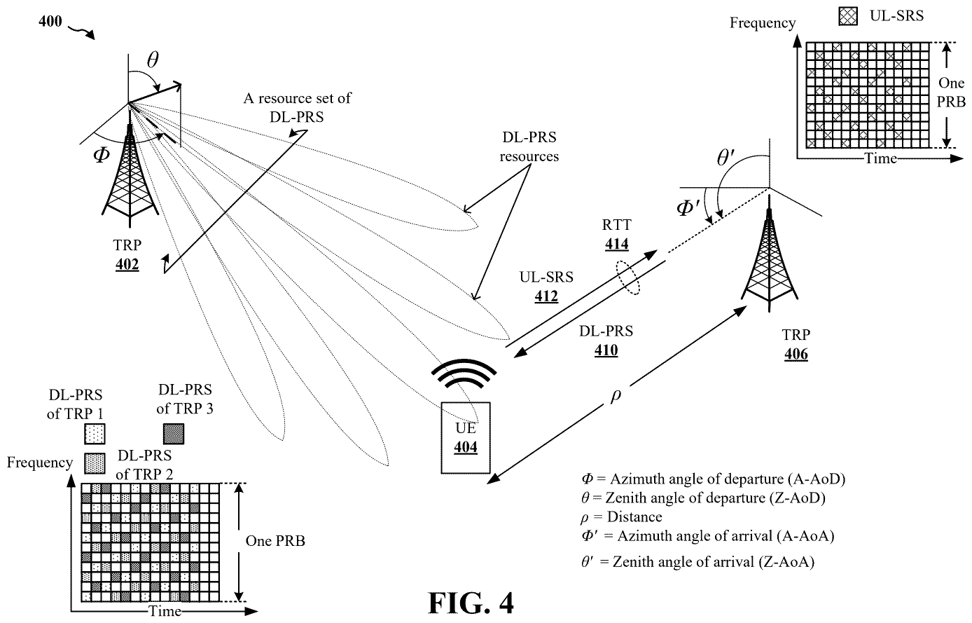

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}|. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406. DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404. UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

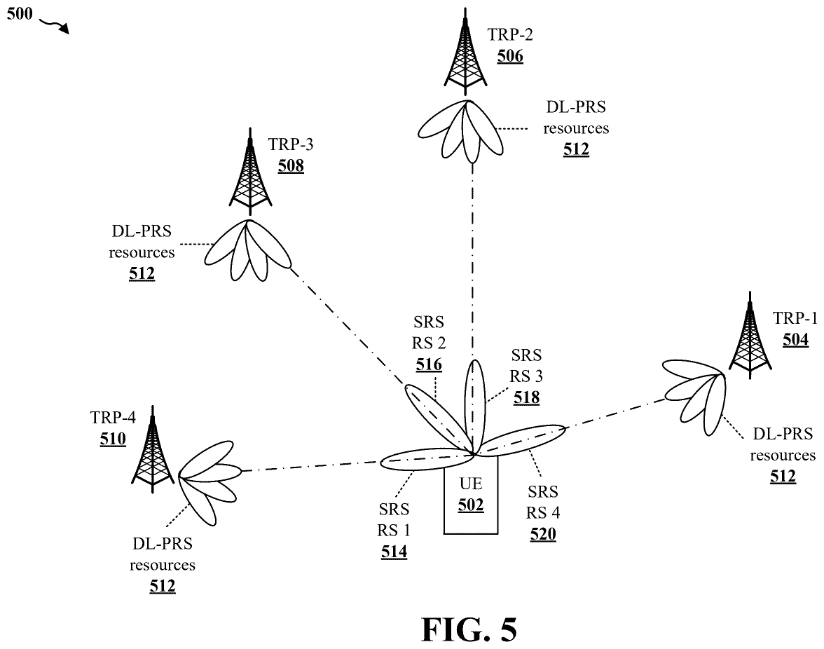

FIG. 5 is a diagram 500 illustrating an example of estimating a position of a UE based on multi-RTT measurements from multiple TRPs in accordance with various aspects of the present disclosure. A UE 502 may be configured by a serving base station to decode DL-PRS resources 512 that correspond to and are transmitted from a first TRP 504 (TRP-1), a second TRP 506 (TRP-2), a third TRP 508 (TRP-3), and a fourth TRP 510 (TRP-4). The UE 502 may also be configured to transmit UL-SRSs on a set of UL-SRS resources, which may include a first SRS resource 514, a second SRS resource 516, a third SRS resource 518, and a fourth SRS resource 520, such that the serving cell(s), e.g., the first TRP 504, the second TRP 506, the third TRP 508, and the fourth TRP 510, and as well as other neighbor cell(s), may be able to measure the set of the UL-SRS resources transmitted from the UE 502. For multi-RTT measurements based on DL-PRS and UL-SRS, as there may be an association between a measurement of a UE for the DL-PRS and a measurement of a TRP for the UL-SRS, the smaller the gap is between the DL-PRS measurement of the UE and the UL-SRS transmission of the UE, the better the accuracy may be for estimating the position of the UE and/or the distance of the UE with respect to each TRP.

In some aspects of wireless communication, the terms “positioning reference signal” and “PRS” may generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. In some aspects, a downlink positioning reference signal may be referred to as a “DL-PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

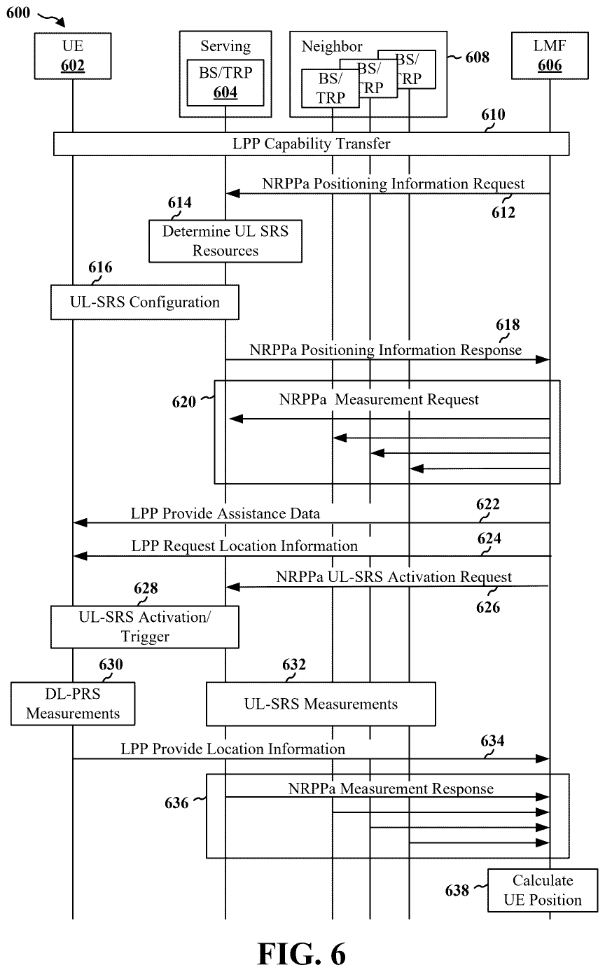

FIG. 6 is a communication flow 600 illustrating an example multi-RTT positioning procedure in accordance with various aspects of the present disclosure. The numberings associated with the communication flow 600 do not specify a particular temporal order and are merely used as references for the communication flow 600. In addition, a DL-only and/or an UL-only positioning may use a subset or subsets of this multi-RTT positioning procedure.

At 610, an LMF 606 may request one or more positioning capabilities from a UE 602 (e.g., from a target device). In some examples, the request for the one or more positioning capabilities from the UE 602 may be associated with an LTE Positioning Protocol (LPP). For example, the LMF 606 may request the positioning capabilities of the UE 602 using an LPP capability transfer procedure. At 612, the LMF 606 may request UL SRS configuration information for the UE 602. The LMF 606 may also provide assistance data specified by a serving base station 604 (e.g., pathloss reference, spatial relation, and/or SSB configuration(s), etc.). For example, the LMF 606 may send an NR Positioning Protocol A (NRPPa) positioning information request message to the serving base station 604 to request UL information for the UE 602.

At 614, the serving base station 604 may determine resources available for UL SRS, and at 616, the serving base station 604 may configure the UE 602 with one or more UL SRS resource sets based on the available resources. At 618, the serving base station 604 may provide UL SRS configuration information to the LMF 606, such as via an NRPPa positioning information response message. At 620, the LMF 606 may select one or more candidate neighbor BSs/TRPs 608, and the LMF 606 may provide an UL SRS configuration to the one or more candidate neighbor BSs/TRPs 608 and/or the serving base station 604, such as via an NRPPa measurement request message. The message may include information for enabling the one or more candidate neighbor BSs/TRPs 608 and/or the serving base station to perform the UL measurements.

At 622, the LMF 606 may send an LPP provide assistance data message to the UE 602. The message may include specified assistance data for the UE 602 to perform the DL measurements. At 624, the LMF 606 may send an LPP request location information message to the UE 602 to request multi-RTT measurements. At 626, for semi-persistent or aperiodic UL SRS, the LMF 606 may request the serving base station 604 to activate/trigger the UL SRS in the UE 602. For example, the LMF 606 may request activation of UE SRS transmission by sending an NRPPa positioning activation request message to the serving base station 604.

At 628, the serving base station 604 may activate the UE SRS transmission and send an NRPPa positioning activation response message. In response, the UE 602 may begin the UL-SRS transmission according to the time domain behavior of UL SRS resource configuration. At 630, the UE 602 may perform the DL measurements from the one or more candidate neighbor BSs/TRPs 608 and/or the serving base station 604 provided in the assistance data. At 632, each of the configured one or more candidate neighbor BSs/TRPs 608 and/or the serving base station 604 may perform the UL measurements. At 634, the UE 602 may report the DL measurements to the LMF 606, such as via an LPP provide location information message. At 636, each of the one or more candidate neighbor BSs/TRPs 608 and/or the serving base station 604 may report the UL measurements to the LMF 606, such as via an NRPPa measurement response message. At 638, the LMF 606 may determine the RTTs from the UE 602 and BS/TRP Rx-Tx time difference measurements for each of the one or more candidate neighbor BSs/TRPs 608 and/or the serving base station 604 for which corresponding UL and DL measurements were provided at 634 and 636, and the LMF 606 may calculate the position of the UE 602.

Aspects of wireless communication may utilize a number of different routes or areas during a position location process for a device (e.g., an Internet of Things (IoT) device). For instance, a position location process may utilize a perimeter or a geofence (i.e., a virtual perimeter around a real-world geographic area) to assist in determining a location of a device. In some aspects, position location processes utilizing geofences may instruct a mobile device to actively measure the location of the device. This active measurement by the device may be utilized to determine whether the device is within the designated area of a geofence, or to determine whether the device has breached the designated area of the geofence. However, active measurement may cause excessive power consumption at the device, such that any benefit in accuracy and latency may not be worthwhile. For instance, the frequency of any active measurement may result in a tradeoff between accuracy/latency of positioning within the geofence in favor of power consumption at the device.

In some instances, a position location system may indicate for a device to reduce a duty cycle of an active measurement by a certain amount (e.g., reduce the duty cycle by 25%). However, this reduction in duty cycle may result in a loss of accuracy/latency, but not result in a corresponding benefit in reduced power consumption at the device. Accordingly, any power savings for reducing the duty cycle of active measurement may not be sufficiently beneficial to the device. Based on the above, it may be beneficial to favor the power consumption at a device over the accuracy/frequency of reporting when the device is within a geofence (or the geofence has been breached). For example, when tracking a remote shipment, if a shipment deviates from a geofence, reporting the accuracy or latency regarding the breach may not be sufficiently beneficial to the device compared to reporting the breach at a designated time period or within a certain time period (e.g., within a threshold number of minutes). Additionally, it may be beneficial to take a system-level approach to reducing power consumption at a device in a position location system, rather than a device-level approach (e.g., reducing the duty cycle of active measurement at the device). That is, it may be beneficial to consider the overall position location system for devices within geofences in order to reduce the power consumption at a specific device, instead of considering the active measurement of the specific device.

Aspects of the present disclosure may improve the power consumption of devices in position location systems. For instance, aspects presented herein may prioritize the power consumption at a device over the accuracy/frequency of reporting whether the device is within a certain range (e.g., a geofence). In some instances, aspects presented herein may take a system-level approach to reducing power consumption at a device. For example, aspects of the present disclosure may consider the overall position location system for devices within geofences in order to reduce the power consumption at a specific device. Additionally, devices herein may obtain motion data or environmental data associated with a device along a certain route. Devices herein may determine whether the obtained data is inconsistent with preconfigured/expected motion data or preconfigured/expected environmental data. Further, aspects presented herein may notify a server/network in a position location system when the obtained data is inconsistent with preconfigured/expected motion data or preconfigured/expected environmental data.

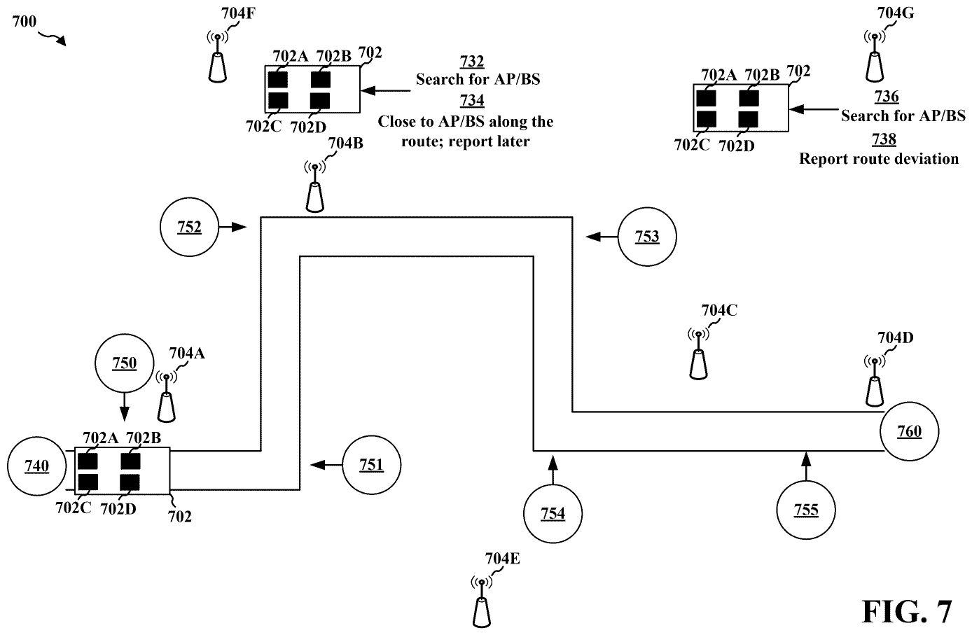

In some aspects, devices (e.g., wireless devices or UEs) may be configured or preconfigured with a certain route or path. For instance, a network or server may transmit a configuration or preconfiguration to a device prior to a certain route or path. The configuration or preconfiguration may indicate an expected route or expected points along the route for the device. Also, the configuration/preconfiguration may indicate a sequence in which the expected points will occur along the route, as well as a sequence of the overall expected route. For example, the configuration/preconfiguration may indicate the following sequence to the device: (i) left turn or left motion pattern at a first point (point 1), (ii) right turn or right motion pattern at a second point (point 2), (iii) right turn or right motion pattern at a third point (point 3), (iv) left turn or left motion pattern at a fourth point (point 4), and (v) a pothole or a pothole motion pattern at a fifth point (point 5). For instance, this motion sequence may correspond to the motion sequence indicated in FIG. 7, as described below. In addition to transmitting a configuration to a device prior to the start of a certain route or path, the server or network may transmit a configuration to the device during a route or path. For example, the server or network may transmit information (e.g., small data transmission (SDT) information) configuring the device based on certain route conditions (e.g., traffic conditions, road conditions, weather conditions, etc.) that may affect which route or path is taken by the device. The configuration/preconfiguration may also include elevation information or certain elevation criteria, such as a maximum elevation that the device measures prior to triggering an elevation report. Additionally, the configuration/preconfiguration may indicate road conditions and/or typical stops along the route, which may be crowdsourced from other devices and based on typical motion patterns. The configuration/preconfiguration may also include a number of access points (APs) or base stations (BSs) associated with the route. This may include APs or BSs that the device may encounter or detect along the route, as well as APs or BSs that are outside of the route. In some aspects, the amount of APs or BSs that are outside of the route may be less than the amount of APs or BSs within the route, such that the APs or BSs that are outside of the route may be a sparser data set compared to APs or BSs within the route. For instance, the data set of APs or BSs that are outside of the route may be used to identify when a device is off-route or outside of the route. Alternatively, in some aspects, the amount of APs or BSs that are within the route may be less than the amount of APs or BSs outside the route, such that the APs or BSs that are outside of the route may be a sparser data set compared to APs or BSs outside of the route. Moreover, the device may be configured with distances associated with each motion event along the route, such as distances before and after each motion event, so the device may be able to extrapolate its position along the route.

In some aspects, a device may determine whether certain motion data along the route corresponds to a preconfigured motion event for the route. For instance, a device may determine whether two-dimensional (2D) or three-dimensional (3D) motion data corresponds to a preconfigured motion event. This motion data may be obtained from a certain device, such as an inertial measurement unit (IMU) or a gyroscope. Further, the preconfigured motion event may be associated with a particular sequence of events, such as an expected event (e.g., an event that is subsequent to a current time) in a sequence of events. In some instances, if the motion event does not correspond to the expected event in the sequence of events, this inconsistency may be a triggering event (i.e., an event that triggers a report of the inconsistency). For example, if the motion event does not correspond to the expected event in the sequence of events, the device may transmit an indication (e.g., a report) to the server in order to indicate that the motion event does not correspond to the expected event. In some aspects, device movements during transport may be inferred based on certain motion data (e.g., IMU data or gyroscope data). For instance, device movements may be inferred based on machine learning (ML) procedures, as well as based on heuristics and/or thresholding procedures, in order to identify when certain device movements are made (e.g., a right turn, a left turn, a U-turn, etc.). The status of a current device location may also be inferred based on motion data (e.g., the device accesses a highway on-ramp, a highway off-ramp, or a highway exit). Further, device movements may be inferred based on different levels of motion sensitivity. For example, for a certain level of motion sensitivity, device movements may be inferred based on motion data or a motion pattern classification. Also, for different levels of motion sensitivity, device movements may be inferred based on other types of information (e.g., speed change information for the device, road status information for the route, etc.).

Additionally, the device may wake-up and search for access points or base stations in its vicinity, such as in response to motion data not corresponding to an expected preconfigured motion event. For instance, the device may initiate a wake-up state or active mode when the obtained motion data is inconsistent with an expected preconfigured motion event. By waking-up when the obtained motion data is inconsistent with an expected preconfigured motion event, the device may be able to save power. That is, a device may remain in a sleep mode if the motion data is consistent with an expected preconfigured motion event, which saves power compared to an active mode. Indeed, the wake-up state or active mode may utilize more power at the device compared to the sleep mode, so by remaining in a sleep mode when the motion data is consistent with expected events, the device may save power. As such, in some aspects, the device may solely trigger the wake-up state or active mode (and thus utilize an increased amount of power) if the obtained motion data is inconsistent with an expected preconfigured motion event. Alternatively, the device may initiate a wake-up state when the obtained motion data is consistent with an expected preconfigured motion event. Indeed, the wake-up state or active mode initiation at the device may be based on a consistency or an inconsistency with a preconfigured motion event. If APs or BSs correspond to an expected location of the device along the route, the device may store the motion pattern for reporting it at a later time. The device may also modify the motion pattern sequence to adjust for any potentially missed motion pattern sequence and/or sensor.

In some aspects, if access points or base stations correspond to a location outside of the route (i.e., a route deviation), the device may connect to a network or server and report the route deviation. In some circumstances, the APs or BSs may correspond to a report list, which may be tiered where each tier corresponds to how the device should report certain information. For example, a first set of APs/BSs may be on the route or adjacent to the route and correspond to a first tier, such that the device may report these APs/BSs at preconfigured time. A second set of APs/BSs may correspond to a route deviation and may be in a second tier, such that the device may change a duty cycle (e.g., a duty cycle of a global navigation satellite system (GNSS)) and report these APs/BSs at a particular time. A third set of APs/BSs may correspond to a potential theft, such that the device may immediately connect to the network and start reporting positions more frequently. Further, in response to the motion data corresponding to an expected preconfigured motion event, the device may selectively wake-up and search for APs/BSs in its vicinity along the route. That is, the device may not immediately wake-up and search for APs/BSs in its vicinity if the motion data corresponds to a preconfigured motion event. Rather, if the motion data corresponds to a preconfigured motion event, the device may wake-up and search for APs/BSs at a preconfigured time instance. Moreover, the device may selectively wake-up and search for APs/BSs based on a number of factors, such as total time elapsed, time elapsed since a last search, distance measured (e.g., distance obtained from an IMU), or any combination thereof.

FIG. 7 is a diagram 700 illustrating an example route for a device 702 traveling from an origin point 740 to a destination point 760. In some aspects, the device 702 may be on a moving object (e.g., a vehicle, an automobile, a boat, an airplane, etc.) carrying a set of other devices including device 702A, device 702B, device 702C, and device 702D. In some aspects, the set of other devices may be devices associated with items to be carried from the origin point 740 to the destination point 760. In some aspects, the device 702 may be configured with a route associated with a motion pattern or a set of motion events (e.g., the device 702 may be configured with the route before the device 702 departs from the origin point 740).

In some aspects, as depicted in FIG. 7, the motion pattern may include an expected sequence of events that may be determined (e.g., by a server (not shown) managing the device 702) to be expected to occur while the device 702 travels from the origin point 740 to the destination point 760. In some aspects, the sequence of events in the motion pattern may correspond to (or may be based on) an absolute location of the device 702. For example, the sequence of events may include events related to certain types of movement of the device (e.g., straight movement, a left turning movement, or a right turning movement). Further, the sequence of events may include elevation changes of the device 702, such as elevating or descending, with regard to a certain level (e.g., sea level). As illustrated in FIG. 7, the motion pattern may include, by way of example, one or more events at different locations, such as moving straight at point 750, a left turn at point 751, a right turn at point 752, a right turn at point 753, a left turn at point 754, and moving straight at point 755. In some aspects, the absolute location may be based on 2D or 3D motion data, such as IMU data, gyroscope data, or other data that the device 702 may obtain for determining the absolute location. As used herein, the term “absolute location” may refer to a location (e.g., in longitude, latitude, or altitude) with regard to Earth. Additionally, movements of the device 702 may be inferred based on motion data (e.g., IMU data or gyroscope data). For instance, movements of device 702 may be inferred based on ML procedures, heuristics, and/or thresholding procedures in order to identify when the device 702 makes certain movements (e.g., a right turn, a left turn, a U-turn, etc.). The current location of device 702 may also be inferred based on motion data (e.g., the device 702 accesses a highway on-ramp, a highway off-ramp, or a highway exit). Also, movements of device 702 may be inferred based on different levels of motion sensitivity. For example, for a certain level of motion sensitivity, movements of device 702 may be inferred based on motion data or a motion pattern classification. Moreover, for different levels of motion sensitivity, movements of device 702 may be inferred based on other types of information (e.g., speed change information for the device and/or road status information for the route).

As depicted in FIG. 7, the one or more events at different locations may correspond to (or may be based on) one or more relative positions of the device 702. For example, the one or more relative positions of the device 702 may correspond to the device 702A, the device 702B, the device 702C, or the device 702D. The device 702 may be ranging with the device 702A, the device 702B, the device 702C, or the device 702D and may determine an angle of arrival (AoA) between the device 702 and the device 702A, the device 702B, the device 702C, or the device 702D. The one or more patterns at the one or more locations may correspond to (or may be based on) the ranging and the AoA. For example, the one or more events at the one or more locations may include that at certain points (e.g., point 750, point 751, point 752, point 753, point 754, or point 755), the device 702 is expected to have an unchanged relative location including an unchanged ranging (e.g., may include a fluctuation within a defined margin) and an unchanged AoA (e.g., may include a fluctuation within a defined margin) with regard to each of the device 702A, the device 702B, the device 702C, or the device 702D. As used herein, the term “relative location” may refer to a location (e.g., in terms of distance and AoA) with regard to one or more devices.

Additionally, as depicted in FIG. 7, the device 702 may be configured with information regarding a set of access points or base stations along the route. For example, the device 702 may be configured with information regarding base station 704A, base station 704B, base station 704C, and base station 704D along the route.

In some aspects, information regarding the set of access points or base stations along the route may be associated with the motion pattern or set of expected motion events. For example, the device 702 may be configured with information that the device 702 may (i) wake-up and expect to detect the base station 704A at point 750, (ii) wake-up and expect to detect the base station 704B at point 752, or (iii) wake-up and expect to detect the base station 704C and 704D at point 755. In some aspects, the device 702 may be configured with information regarding a set of access points or base stations that are not along the route. For example, the device 702 may be configured with information regarding base station 704E, base station 704F, and base station 704G. In some aspects, information regarding the set of access points or base stations not along the route may be associated with reporting these access points/base stations. In some aspects, information regarding the set of access points or base stations not along the route may be a sparser data set (e.g., with reduced information, a reduced amount of associated base stations/access points, or a reduced density in terms of the number of base stations/access points in an area) compared with information regarding the set of access points or base stations along the route. For example, the device 702 may be configured to save and report a location and a time at a later instance if the device 702 detects the base station 704E. As another example, the device 702 may be configured to report a location and a time to the network upon detecting the base station 704E or the base station 704G. In some aspects, the device 702 may be configured with a tier or associated reporting for each of the access points or base stations in the set of access points/base stations along the route, as well as the set of access points/base stations not along the route. The tier or associated reporting may represent configured actions (e.g., (i) save and report a location and time at a later configured instance, (ii) report a location and time to the network, or (iii) change a duty cycle of reporting or positioning) associated with the device 702 upon detecting the access point or base station.

As further depicted in FIG. 7, the device 702 may be configured to report its location (e.g., absolute or relative location) or other motion data at one or more configured time instances based on a duty cycle. In addition, as the device 702 travels from the origin point 740 to the destination point 760, the device 702 may determine whether motion data (e.g., based on an absolute location or a relative location) corresponds to the configured motion pattern and associated events. In some aspects, in response to the motion data not corresponding to an event associated with the configured motion pattern, the device 702 may take various actions (e.g., that may be configured and associated with the motion pattern). For example, as illustrated in FIG. 7, at point 752, instead of turning right, the device 702 may keep moving straight and may deviate from the configured route. In some aspects, in response to the deviation from the configured route, at 732, the device 702 may report the route deviation (at 738), search for an access point or a base station, and accordingly detect the base station 704B and the base station 704F. In some aspects, the device 702 may be configured, in response to detecting the base station 704B and the base station 704F, (at 734) to determine to report (e.g., such as report the location of device 702) at a later configured time. In some aspects, the device 702 may be configured to report at the later configured time upon detecting the base station 704B and the base station 704F, as the base station 704E may be configured to be associated with a tier associated with the action of reporting at a later configured time. In some aspects, the device 702 may be configured to report at the later configured time upon detecting the base station 704B and the base station 704F because the base station 704B is close to the route.

Moreover, as depicted in FIG. 7, at a later time (e.g., at 736) after deviating from the configured route at point 752, the device 702 may wake-up and search for an access point or base station. In some aspects, at 736, the device 702 may detect the base station 704G. In some aspects, the device 702 may be configured, in response to detecting the base station 704G, to determine to connect to the network via the base station 704G and report the location of device 702 (such as an absolute or relative location). The device 702 may also report, by way of example, a number of other devices that are encountered along the route. Further, the device 702 may report any inconsistencies in the expected motion pattern. In some aspects, the device 702 may be configured to connect with the network and report the location of device 702 upon detecting the base station 704G, which may be based on the base station 704G corresponding to a tier associated with the action of connecting to the network and reporting the location of device 702. In some aspects, the device 702 may be configured to connect to the network and report the location of device 702 upon detecting the base station 704G because detecting the base station 704G may indicate a deviation from the route by a certain threshold. In some aspects, in addition to reporting the device location, the device 702 may also change a reporting cycle for the device upon detecting the base station 704G. Additionally, the device 702 may be configured (by a server or network) with certain information at the start of a route or path (e.g., from origin point 740 to destination point 760) or during a route or path. For example, the server or network may transmit information (e.g., small data transmission (SDT) information) that configures the device 702 based on certain route conditions (e.g., traffic conditions, road conditions, weather conditions, etc.) that may affect which route or path is taken by the device 702. The device 702 may be configured by a number of different servers, such as a server associated with a network or a server not associated with a network. For example, the server may be a cloud server or a third party server. Further, the server may be an edge server or an edge service associated with a software application, such as a software application running on hardware associated with a network entity (e.g., an RU, a DU, and/or a CU). The hardware associated with the network entity may be network-agnostic hardware or network-specific hardware, as well as a mix of different hardware that is network-agnostic hardware and/or network-specific hardware.

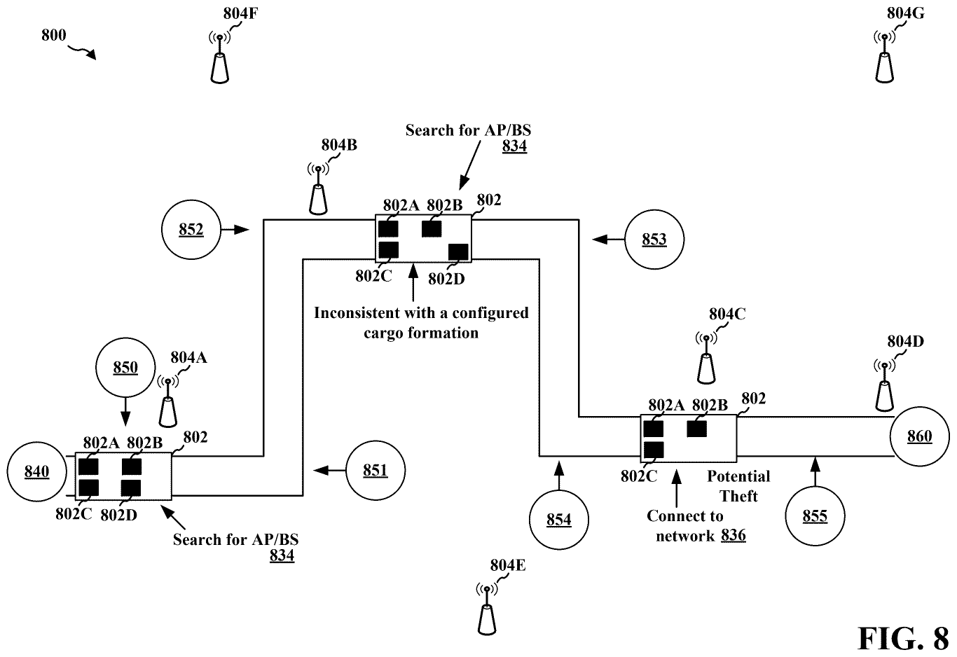

FIG. 8 is a diagram 800 illustrating another example route for a device 802 traveling from an origin point 840 to a destination point 860. In some aspects, the device 802 may be on a moving object (e.g., a vehicle, an automobile, a boat, an airplane, etc.) carrying one or more other devices including device 802A, device 802B, device 802C, and device 802D. For instance, the devices 802A, 802B, 802C, and 802D may be cargo or items on device 802. Similar to device 702 in FIG. 7, device 802 may be configured with a route associated with a motion pattern or a set of motion events (e.g., the device 802 may be configured with the route before the device 802 departs from the origin point 840). As depicted in FIG. 8, the motion pattern may include an expected sequence of events that may be determined (e.g., by a server (not shown) managing the device 802) to be expected to occur while the device 802 travels from the origin point 840 to the destination point 860. One or more events at different locations may correspond to (or may be based on) relative positions of the device 802. For example, the relative positions of the device 802 may correspond to the device 802A, the device 802B, the device 802C, or the device 802D. Moreover, the device 802 may be configured with information regarding a set of access points or base stations along the route. For example, the device 802 may be configured with information regarding base station 804A, base station 804B, base station 804C, and base station 804D along the route. In some aspects, information regarding the set of access points or base stations along the route may be associated with the motion pattern or set of expected motion events. For example, the device 802 may be configured with information that the device 802 may (i) wake-up and expect to detect the base station 804A at point 850, (ii) wake-up and expect to detect the base station 804B at point 852, or (iii) wake-up and expect to detect the base station 804C and 804D at point 855. In some aspects, the device 802 may be configured with information regarding a set of access points or base stations that are not along the route. For example, the device 802 may be configured with information regarding base station 804E, base station 804F, and base station 804G.

As further depicted in FIG. 8, the device 802 may be configured to report its cargo-related information (e.g., regarding device 802A, device 802B, device 802C, and device 802D) or other cargo data at configured time instances. In addition, as the device 802 travels from the origin point 840 to the destination point 860, the device 802 may determine whether observed cargo data corresponds to the configured cargo data (e.g., based on a configured cargo formation of the device). In some aspects, in response to the cargo data not corresponding to the configured cargo formation, the device 802 may take various actions (e.g., that may be configured and associated with the cargo formation). For example, at point 850 or point 851, device 802 may determine whether a current cargo formation (e.g., regarding a formation of device 802A, device 802B, device 802C, and device 802D) is consistent with the starting cargo formation at 840. If the current cargo formation is consistent with the starting cargo formation, the device 802 may not report back to the network/server and continue along the route. At point 852, the device 802 may again determine whether the current cargo formation is consistent with the starting cargo formation. As shown in FIG. 8, if the current cargo formation is inconsistent with the starting cargo formation at 840, the device 802 may report this inconsistency to a network/server. At this time, the device 802 may search for an AP/BS at 834, or search for an AP/BS at a later time. At point 854, the device 802 may again determine whether the current cargo formation is consistent with the starting cargo formation at 840. As shown in FIG. 8, the device may determine there is an inconsistency with the starting cargo formation based on a missing piece of cargo, such as due to a potential theft. Based on this determination, the device 802 may connect to the network/server at 836, and report this inconsistency. The device 802 may be configured by a number of different servers, such as a server associated with a network or a server not associated with a network. For example, the server may be a cloud server or a third party server. Further, the server may be an edge server or an edge service associated with a software application, such as a software application running on hardware associated with a network entity (e.g., an RU, a DU, and/or a CU). The hardware associated with the network entity may be network-agnostic hardware or network-specific hardware, as well as a mix of different hardware that is network-agnostic hardware and/or network-specific hardware.

In some aspects, a device may also be configured with a motion pattern and/or quantized measurements (e.g., IMU measurements, gyroscope measurements, or magnetometer measurements). A network or server may utilize this information to identify if there are any potential unplanned events (e.g., a spoof, a theft attempt, an accident, a fall or dropped cargo). Also, the network/server may determine if these unplanned events are being experienced by one device on the route, but not other devices on the route. Further, a device may be preconfigured to wait a particular amount of time or distance after a certain motion event before performing measurements for reporting back to the network/server. For example, a device may be triggered by a certain event (e.g., a device on a flight may be triggered by a landing), but the device may not immediately start performing measurements. That is, the device may determine to wait a predetermined time/distance after the triggering event before performing such measurements. Moreover, a device may be preconfigured to use a particular technology based on a certain motion event and may use another technology after another motion event, time duration, or distance traveled. For example, device may be triggered by a certain event (e.g., a device on a flight may be triggered by a landing) to measure certain signals (e.g., wireless wide area network (WWAN) signals) in order to determine a general location. However, the device may wait for a certain period/distance (e.g., until the device has stopped moving) to start the measurements, which may trigger different signal measurements (e.g., wireless local area network (WLAN) signal measurements) for a different location estimate (i.e., an improved location estimate). Additionally, instead of AP/BS search reporting, a device may utilize a triggering event to determine an absolute position (e.g., via terrestrial ranging, GNSS, Bluetooth low energy (BLE), ultra wideband (UWB), etc.). The device may also utilize other technologies, such as capturing images and providing them to the server. Further, the device may perform a feature identification on the device to determine a location of the device, which may be performed with different detection/ranging methods (e.g., light detection and ranging (LiDAR) or radio detection and ranging (RADAR)). In some instances, if the device is just reporting measurement data (e.g., image data), a network/server may be used to determine a location for the device, as well as store the location of the device for reporting to a third device and/or user. A device may also report its location measurements with reference to different checkpoints. In one embodiment, even if a device has moved past a particular checkpoint by the time it wakes up and performs location measurements, the device may report the time at which it moved past that particular checkpoint.

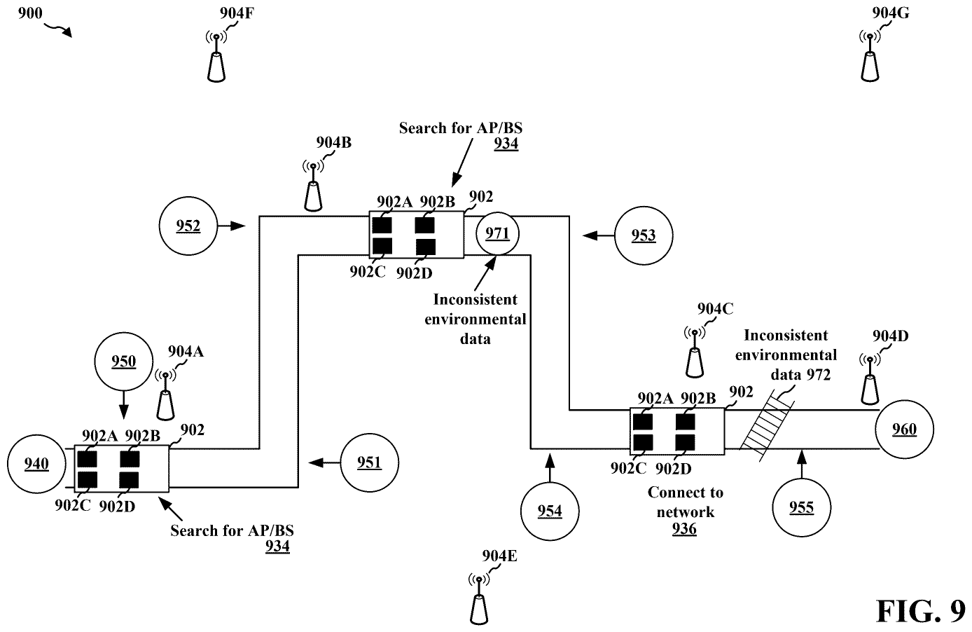

FIG. 9 is a diagram 900 illustrating another example route for a device 902 traveling from an origin point 940 to a destination point 960. In some aspects, the device 902 may be on a moving object (e.g., a vehicle, an automobile, a boat, an airplane, etc.) carrying one or more other devices including device 902A, device 902B, device 902C, and device 902D. For instance, the devices 902A, 902B, 902C, and 902D may be cargo or items on device 902. Similar to device 702 in FIG. 7 and device 802 in FIG. 8, device 902 may be configured with a route associated with a motion pattern or a set of motion events (e.g., the device 902 may be configured with the route before the device 902 departs from the origin point 940). As depicted in FIG. 9, the motion pattern may include an expected sequence of events that may be determined (e.g., by a server (not shown) managing the device 902) to be expected to occur while the device 902 travels from the origin point 940 to the destination point 960. One or more events at different locations may correspond to (or may be based on) relative positions of the device 902. For example, the relative positions of the device 902 may correspond to the device 902A, the device 902B, the device 902C, or the device 902D. Additionally, the device 902 may be configured with information regarding a set of access points or base stations along the route. For example, the device 902 may be configured with information regarding base station 904A, base station 904B, base station 904C, and base station 904D along the route. In some aspects, information regarding the set of access points or base stations along the route may be associated with the motion pattern or set of expected motion events. For example, the device 902 may be configured with information that the device 902 may (i) wake-up and expect to detect the base station 904A at point 950, (ii) wake-up and expect to detect the base station 904B at point 952, or (iii) wake-up and expect to detect the base station 904C and 904D at point 955. In some aspects, the device 902 may be configured with information regarding a set of access points or base stations that are not along the route. For example, the device 902 may be configured with information regarding base station 904E, base station 904F, and base station 904G.

As depicted in FIG. 9, the device 902 may be configured to report environment-related information regarding the route at one or more configured time instances. Also, as the device 902 travels from the origin point 940 to the destination point 960, the device 902 may determine whether observed environmental data (e.g., based on the surrounding conditions of the route) corresponds to configured environmental data or an expected environmental pattern. This environmental data or an expected environmental pattern may be received from a network or server (not shown). In some aspects, in response to the observed environmental data not corresponding to configured environmental data or an expected environmental pattern, the device 902 may take various actions (e.g., that may be configured and associated with the environmental pattern). For example, at point 950 or point 951, device 902 may determine whether the observed environmental data (e.g., based on the surrounding conditions of the route) is consistent with the expected environmental pattern. If the environmental data is consistent with the expected environmental pattern, the device 902 may not report back to the network/server and continue along the route. At point 952 or point 953, the device 902 may again determine whether the observed environmental data is consistent with the expected environmental pattern. If the observed environmental data is inconsistent with the expected environmental pattern (e.g., environmental data 971 is inconsistent with an expected environmental pattern), the device 902 may report this inconsistency to a network/server. For example, device 902 may detect that environmental data 971 is rain, snow, or a puddle in the route. At this time, the device 902 may search for an AP/BS at 934, or search for an AP/BS at a later time. At point 954, the device 902 may again determine whether the observed environmental data is consistent with the expected environmental pattern. As shown in FIG. 9, the device may determine there is an inconsistency with the expected environmental pattern (e.g., environmental data 972 is inconsistent with the expected environmental pattern) based on the surrounding environment (e.g., rain, snow, a puddle, etc.) or an object on the route (e.g., a ladder as shown in environmental data 972). The inconsistency in the environment may be due to a number of different environmental factors (e.g., a temperature of the surrounding environment, a pressure of the surrounding environment, a surrounding electromagnetic environment, etc.). Based on this determination of an inconsistency in the environment, the device 902 may connect to the network/server at 936, and report this inconsistency to the network/server. Moreover, the device 902 may be configured (by a server or a network) with certain information at the start of a route or path (e.g., from origin point 940 to destination point 960) or during a route or path. For example, the server or network may transmit information (e.g., SDT information) that configures the device 902 based on certain route conditions (e.g., traffic conditions, road conditions, weather conditions, etc.) that may affect which route or path is taken by the device 902. The device 902 may be configured by a number of different servers, such as a server associated with a network or a server not associated with a network. For example, the server may be a cloud server or a third party server. Further, the server may be an edge server or an edge service associated with a software application, such as a software application running on hardware associated with a network entity (e.g., an RU, a DU, and/or a CU). The hardware associated with the network entity may be network-agnostic hardware or network-specific hardware, as well as a mix of different hardware that is network-agnostic hardware and/or network-specific hardware.

Additionally, a network or server may send an indication of certain motion patterns to the device. Further, a network/server may indicate how context may affect or change the output of the motion patterns. For example, the context that affects or changes the output of the motion patterns may be related to an inconsistency in the cargo of the device. As shown in FIG. 8, an expected motion pattern may be similar between certain points on the route (e.g., point 854 and point 855). At point 854, the network/server may indicate that a cargo pallet is to be loaded on (or off) the device to transport to/from another device (e.g., an airplane, boat, automobile, etc.). However, at point 855, the network/server may indicate a potential theft of a cargo pallet on the device 802 (e.g., a theft of device 802D). This indication of a potential theft may occur if the device 802 is in a geographical area where the cargo pallet is not expected to be unloaded. Also, this indication from the network/server may be related to an inconsistency in a configured cargo formation. For example, as shown in FIG. 8, device 802D may be inconsistent with the configured cargo formation between point 852 and point 853, so an indication may be transmitted relating to this inconsistency.

In some aspects, a network/server may indicate where motion patterns are expected to occur at certain points along the route or within a certain vicinity of the route. For example, as depicted in relation to FIG. 9, a network/server may indicate to device 902 that a motion pattern is as follows: (i) left turn or left motion pattern at point 951, (ii) right turn or right motion pattern at point 952, (iii) right turn or right motion pattern at point 953, (iv) left turn or left motion pattern at point 954, and (v) straight motion pattern at point 955. The network/server may also provide a machine learning (ML) model, a neural network model, or a general motion pattern for motion that is expected to occur at certain points or within a certain vicinity. Also, the network/server may load ML models or motion patterns that may occur along the route in order to help the device identify journey waypoints (e.g., stop/yield signs, left/right turns, speed limit changes, road status changes (residential roads vs. highways), etc.). By doing so, this may help to better determine sleep times and/or significant events that may be important to entities tracking the cargo on the device, such as the device itself or the network/server. The network/server may also indicate a ML model or a general motion pattern to use in a corresponding geographic region along the route. Further, the network/server may indicate a ML model or a general motion pattern to use at a certain time or distance along the route. In some instances, motion patterns may be configured to be interpreted differently based on a number of factors (e.g., geofences, geographic boundaries, Wi-Fi/cellular transmission-reception points (TRPs), time, distance, a particular motion in a sequence, or any combination thereof).

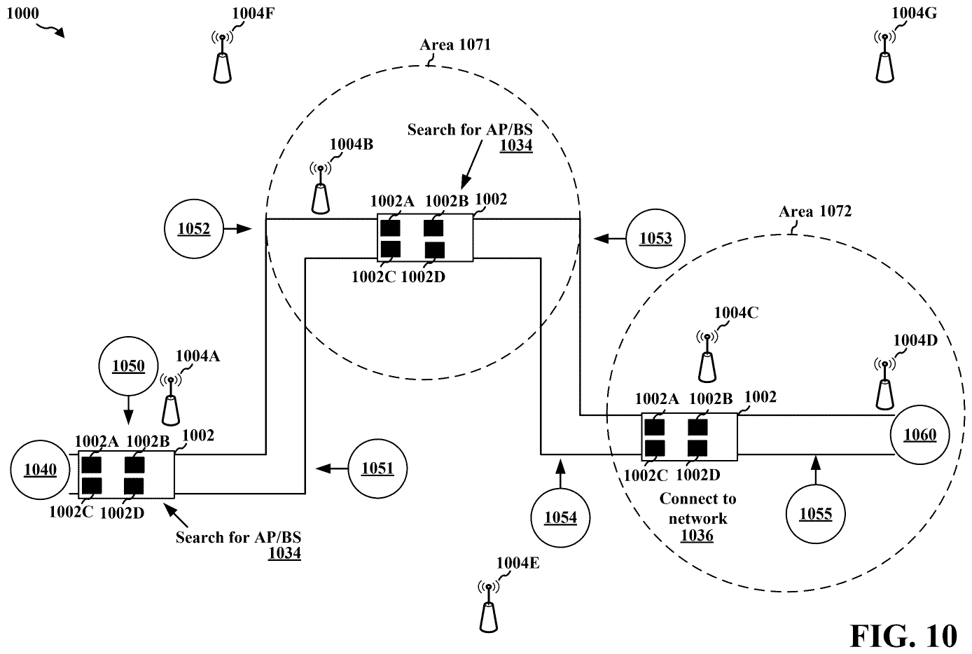

FIG. 10 is a diagram 1000 illustrating another example route for a device 1002 traveling from an origin point 1040 to a destination point 1060. In some aspects, the device 1002 may be on a moving object (e.g., a vehicle, an automobile, a boat, an airplane, or the like) carrying one or more other devices including device 1002A, device 1002B, device 1002C, and device 1002D. For instance, the devices 1002A, 1002B, 1002C, and 1002D may be cargo or items on the device 1002. Similar to device 702 in FIG. 7, device 802 in FIG. 8, and device 902 in FIG. 9, the device 1002 may be configured with a route associated with a motion pattern or a set of motion events (e.g., the device 1002 may be configured with the route before the device 1002 departs from the origin point 1040). As depicted in FIG. 10, the motion pattern may include an expected sequence of events that may be determined (e.g., by a server (not shown) managing the device 1002) to be expected to occur while the device 1002 travels from the origin point 1040 to the destination point 1060. One or more events at different locations may correspond to (or may be based on) relative positions of the device 1002. For example, the relative positions of the device 1002 may correspond to the device 1002A, the device 1002B, the device 1002C, or the device 1002D.

Additionally, the device 1002 may be configured with information regarding a set of access points or base stations along the route. For example, the device 1002 may be configured with information regarding base station 1004A, base station 1004B, base station 1004C, and base station 1004D along the route. In some aspects, information regarding the set of access points or base stations along the route may be associated with the motion pattern or set of expected motion events. For example, the device 1002 may be configured with information that the device 1002 may (i) wake-up and expect to detect the base station 1004A at point 1050 or point 1051, (ii) wake-up and expect to detect the base station 1004B at point 1052, or (iii) wake-up and expect to detect the base station 1004C and 1004D at point 1055. In some aspects, the device 1002 may be configured with information regarding a set of access points or base stations that are not along the route. For example, the device 1002 may be configured with information regarding base station 1004E, base station 1004F, and base station 1004G.

As depicted in FIG. 10, the device 1002 may be configured to report information regarding the route at one or more configured areas or geofences (e.g., area 1071 or area 1072). For instance, as the device 1002 travels from the origin point 1040 to the destination point 1060, the device 1002 may cross a threshold of a configured area or geofence, which may trigger the device to report the route-related information. For example, while traveling from point 1052 to point 1053, the device 1002 may cross a threshold and enter the area 1071 (e.g., a geofence). After crossing the threshold of area 1071, the device may report route-related information to a network or server (not shown), as well as search for an AP/BS (at 1034). Once the device 1002 exits area 1071, the device 1002 may stop reporting route-related information. Similarly, while traveling from point 1054 to point 1055, the device 1002 may cross a threshold and enter the area 1072 (e.g., a geofence). After crossing the threshold of area 1072, the device may connect to a network (at 1036) and report route-related information to a network or server (not shown). Once the device 1002 exits area 1072, the device 1002 may stop reporting route-related information. Alternatively, the device 1002 may be configured to report route-related information while not within a configured area or geofence, so that crossing a threshold into a configured area or geofence may trigger the device 1002 to stop reporting route-related information. The device 1002 may be configured by a number of different servers, such as a server associated with a network or a server not associated with a network. For example, the server may be a cloud server or a third party server. Further, the server may be an edge server or an edge service associated with a software application, such as a software application running on hardware associated with a network entity (e.g., an RU, a DU, and/or a CU). The hardware associated with the network entity may be network-agnostic hardware or network-specific hardware, as well as a mix of different hardware that is network-agnostic hardware and/or network-specific hardware.

In some aspects, a device may search or look for other devices (e.g., peer-to-peer (P2P) devices or UEs) within its vicinity. If the device finds similar P2P devices in a certain proximity along the route, it may report those devices to the network/server. In some instances, if a device is preconfigured with a list of expected P2P devices in a certain proximity (e.g., other tracking devices or transport vehicles), then it may store information in a database regarding those devices. For example, the device may store information regarding a time at which those devices are detected or viewed, as well as information regarding when those devices are no longer detected or viewed. If another device is later detected along the route, the particular database entry for that device may be removed from the database, so the device may indicate the last time the other device is detected. For other devices that are not preconfigured (or not part of a preconfiguration sent to/from the device), this may be useful information that the server can use for various purposes (e.g., identifying potential spoof scenarios, unknown devices being part of the transport, a potential theft, etc.). Additionally, a device may be preconfigured with a list of expected P2P devices along the route. After being preconfigured, the device may use factors (e.g., relative ranging, absolute ranging, angle of arrival (AoA), angle of departure (AoD), etc.) associated with the expected P2P devices in order to trigger reporting. In some scenarios, the device may report a particular motion pattern event along with any nearby devices. Further, the device may report a number of anchors (e.g., sidelink (SL) or ultra wideband (UWB) anchors) along the route. The server may use this information to generate a notification or indicate potential devices detected at the time of the particular motion event. In some instances, the device may report whether other devices are located on the route. The device may detect that another device is located on the route, and determine whether to report this other device to the network/server. The device may determine whether the other device is moving off the route, and if so, the device may not report the other device to the network/server. If the device is not moving off the route, and is blocking the path of the device, the device may report the other device to the network/server. If the other device is not on the route, the device may continue moving and may (or may not) report the other device to the network/server.

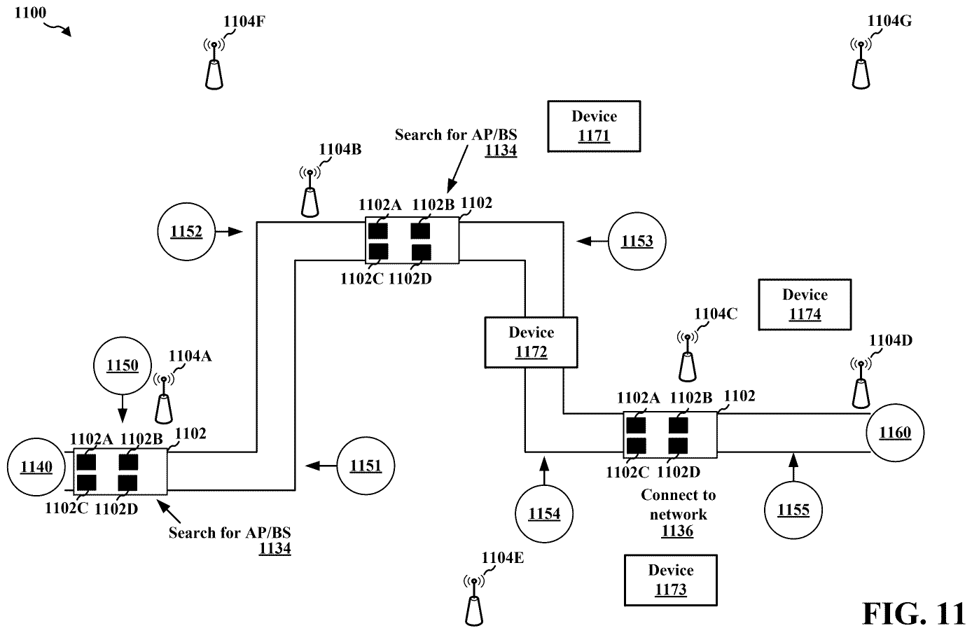

FIG. 11 is a diagram 1100 illustrating another example route for a device 1102 traveling from an origin point 1140 to a destination point 1160. In some aspects, the device 1102 may be on a moving object (e.g., a vehicle, an automobile, a boat, an airplane, etc.) carrying one or more other devices including device 1102A, device 1102B, device 1102C, and device 1102D. For instance, the devices 1102A, 1102B, 1102C, and 1102D may be cargo or items on device 1102. Similar to device 702 in FIG. 7, device 802 in FIG. 8, device 902 in FIG. 9, and device 1002 in FIG. 10, the device 1102 may be configured with a route associated with a motion pattern or a set of motion events (e.g., the device 1102 may be configured with the route before the device 1102 departs from the origin point 1140). As depicted in FIG. 11, the motion pattern may include an expected sequence of events that may be determined (e.g., by a server (not shown) managing the device 1102) to be expected to occur while the device 1102 travels from the origin point 1140 to the destination point 1160. One or more events at different locations may correspond to (or may be based on) relative positions of the device 1102. For example, the relative positions of the device 1102 may correspond to the device 1102A, the device 1102B, the device 1102C, or the device 1102D. Additionally, the device 1102 may be configured with information regarding a set of access points or base stations along the route. For example, the device 1102 may be configured with information regarding base station 1104A, base station 1104B, base station 1104C, and base station 1104D along the route. In some aspects, information regarding the set of access points or base stations along the route may be associated with the motion pattern or set of expected motion events. For example, the device 1102 may be configured with information that the device 1102 may (i) wake-up and expect to detect the base station 1104A at point 1150 or point 1151, (ii) wake-up and expect to detect the base station 1104B at point 1152, or (iii) wake-up and expect to detect the base station 1104C and 1104D at point 1155. In some aspects, the device 1102 may be configured with information regarding a set of access points or base stations that are not along the route. For example, the device 1102 may be configured with information regarding base station 1104E, base station 1104F, and base station 1104G.

As depicted in FIG. 11, the device 1102 may be configured to report device-related information regarding other devices (e.g., P2P devices or UEs) in a proximity of the route. For instance, as the device 1102 travels from the origin point 1140 to the destination point 1160, the device 1102 may detect other devices along the route, which may trigger the device to report device-related information. For example, while traveling from point 1152 to point 1153, the device 1102 may detect other devices (e.g., device 1171 or device 1172) within a certain proximity of the route. As shown in FIG. 11, some other devices (e.g., device 1172) may be located on the route. The device may detect that the other device (e.g., device 1172) is located on the route, and determine whether to report this other device to the network/server. The device may determine whether the other device is moving off the route, and if so, the device may not report the other device to the network/server. If the device is not moving off the route, and is blocking the path of the device, the device may report the other device to the network/server. If the other device is not on the route (e.g., device 1171), the device may continue moving and may (or may not) report the other device to the network/server. After detecting these other devices, the device may report device-related information to a network or server (not shown), as well as search for an AP/BS (at 1134). Once the device 1102 stops detecting the other devices, the device 1102 may stop reporting the device-related information. Similarly, while traveling from point 1154 to point 1155, the device 1102 may detect further devices (e.g., device 1173 or device 1174) within a certain proximity of the route. After detecting these devices, the device 1102 may connect to a network (at 1136) and/or report device-related information to a network or server (not shown). Once the device 1102 stops detecting these other devices, the device 1102 may stop reporting device-related information. Alternatively, the device 1102 may detect other devices that are outside of a certain proximity and report these devices to the network/server. The device 1102 may be configured by a number of different servers, such as a server associated with a network or a server not associated with a network. For example, the server may be a cloud server or a third party server. Further, the server may be an edge server or an edge service associated with a software application, such as a software application running on hardware associated with a network entity (e.g., an RU, a DU, and/or a CU). The hardware associated with the network entity may be network-agnostic hardware or network-specific hardware, as well as a mix of different hardware that is network-agnostic hardware and/or network-specific hardware.

In some aspects, the device may encrypt a list of obtained APs/BSs and other devices (e.g., a breadcrumb trail of devices) and broadcast encrypted data. The device may be preconfigured with at least one key for deciphering information about the encrypted data. For instance, the device may be preconfigured with a public key and/or a private key for deciphering information about encrypted data. The public key may be known to any device (or a large number of devices) within a certain area or proximity, and may be used to indicate certain public information (e.g., a server location for forwarding data and/or a device identifier). The private key may be known to a more limited number of devices (e.g., the device, device owner, and network/server) within the certain area or proximity. Also, the private key may be used to indicate more private information about the device (e.g., the location of the device). In some instances, a specific device (e.g., a reception (Rx) device or receiving device) may be part of a network and forward encrypted data to the network or server along with the location of the specific device.

Additionally, a device may quantize or subdivide a list of devices (e.g., a list of APs/BSs or other devices) regarding certain information. For instance, a device may quantize a list of devices in order to prioritize a certain area or location (e.g., a current location) along the route. In some instances, a device may quantize a list of devices in order to prioritize a current location/section of the route over previous locations/sections of the route. After doing so, the device may transmit the quantized list during a certain state of the device (e.g., a radio resource control (RRC) Inactive state or an RRC Idle state). Also, the device may transmit the quantized list along with a certain type of transmission (e.g., a small data transmission (SDT)). The device may also store an unquantized list of devices (e.g., a list of APs/BSs or other devices). In some instances, when the device enters another state (e.g., an RRC connected state), an unquantized list may be provided to the device. That is, the unquantized list may be sent to the device in one state, and when the device transitions to another state, the device may quantize the list. Alternatively, the device may send the unquantized list and the quantized list in the same state.

Further, motion data obtained by the device may correspond to locations with respect to other objects. For instance, motion data obtained by the device may correspond to a relative location or an absolute location of the device with respect to other objects (e.g., other devices along the route or APs/BSs). For example, multiple devices may be ranging with each another, while each device determines certain information regarding the devices (e.g., the AoD/AoA between the devices). If one device appears to be taking a different route (e.g., a right turn) compared to the other device (e.g., a left turn), such that the device routes are deviating, this route deviation may be used as a triggering event to wake-up one or both of the devices. Moreover, after the deviation triggers a wake-up of one or both of the devices, then one or both of the devices may report back to the network/server regarding the route deviation. Alternatively, one or both of the devices may report back to the network/server without a route deviation between the devices. The frequency of reporting information regarding other devices may be increased or decreased based on a number of factors (e.g., a periodicity of GNSS updates, AP/BS searching, etc.).

Aspects of the present disclosure may include a number of benefits or advantages. For instance, aspects presented herein may improve the power consumption of devices within position location systems. That is, aspects presented herein may prioritize the power consumption at a device over the accuracy of reporting whether the device is within a certain range. For example, aspects of the present disclosure may consider the overall position location system for devices within an area in order to reduce the power consumption at a specific device. Additionally, devices herein may obtain motion data or environmental data associated with the device along a certain route. Devices herein may determine whether the obtained data is inconsistent with preconfigured/expected motion data or preconfigured/expected environmental data. Further, aspects presented herein may notify a server or position location system when the obtained data is inconsistent with preconfigured/expected motion data or preconfigured/expected environmental data. By doing so, devices herein may save power by reporting inconsistencies in preconfigured/expected motion data compared to observed data, rather than reporting all observed data.

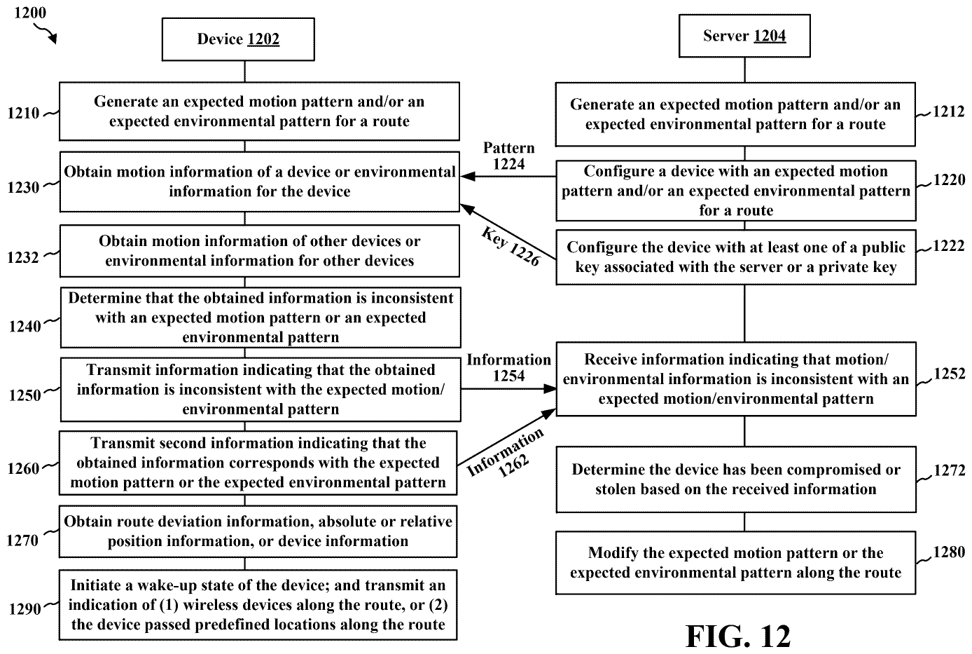

FIG. 12 is a communication flow diagram 1200 of wireless communication in accordance with one or more techniques of this disclosure. As shown in FIG. 12, diagram 1200 includes example communications between device 1202 (e.g., a wireless device or UE) and server 1204 (e.g., a cloud server, a third party server, an edge server, a network, or a network entity), in accordance with one or more techniques of this disclosure. In some aspects, device 1202 may be a first wireless device (e.g., UE, base station, TRP, server, or network entity) and server 1204 may be a second wireless device (e.g., UE, base station, TRP, server, or network entity).

At 1210, device 1202 may generate at least one of an expected motion pattern of a device or an expected environmental pattern of the device for a route based on at least one of motion information of one or more other devices or environmental information associated with the one or more other devices. The route may be a way or course taken in getting from one point (e.g., a starting point) to another point (e.g., a destination point). In some aspects, motion information may be information related to the motion or movement of the device along the route or path. Also, environmental information may be information related to the environment, surroundings, or conditions along the route or path.

At 1212, server 1204 may generate at least one of an expected motion pattern or an expected environmental pattern along a route based on received crowdsourced information indicating at least one of motion pattern or environmental pattern along the route.

At 1220, server 1204 may configure a device with at least one of an expected motion pattern of the device or an expected environmental pattern of the device along a route (e.g., pattern 1224). For example, server 1204 may transmit a configuration to device 1202 in order to configure device 1202 with at least one of an expected motion pattern of the device or an expected environmental pattern of the device along a route (e.g., pattern 1224). Likewise, device 1202 may receive a configuration from the server in order to configure the device with at least one of an expected motion pattern of the device or an expected environmental pattern of the device along a route. Also, the configured at least one of the expected motion pattern of the device or the expected environmental pattern of the device along the route may indicate different types of motion information or different types of environmental information that should be obtained by the device during different segments between waypoints along the route for comparison with the expected motion pattern of the device or the expected environmental pattern of the device.

At 1222, server 1204 may configure the device with at least one of a public key associated with the server or a private key (e.g., key 1226), where received information may be encrypted based on at least one of the public key or the private key. For example, server 1204 may transmit a configuration to device 1202 in order to configure device 1202 with at least one of a public key associated with the server or a private key (e.g., key 1226). Likewise, device 1202 may receive a configuration from the server in order to configure the device with at least one of a public key associated with the server or a private key.

At 1230, device 1202 may obtain, along a route of the device, at least one of motion information of the device or environmental information associated with the device. In some aspects, the motion information of the device or the environmental information of the device may be obtained from the device 1202, the server 1204, or other devices. The motion information may include at least one of a velocity, acceleration, directional changes, elevation changes, or any combination thereof, and the expected motion pattern includes at least one of an expected velocity pattern, an expected acceleration pattern, an expected directional change pattern, an expected elevation change pattern, or any combination thereof, along the route. The environmental information may include at least one of a temperature, a humidity, a pressure, one or more detected wireless signals, electromagnetic radiation, an electromagnetic field, or any combination thereof, and the expected environmental pattern includes at least one of an expected temperature pattern, an expected humidity pattern, an expected pressure pattern, an expected detected wireless signal pattern, an expected electromagnetic radiation pattern, an expected electromagnetic field pattern, or any combination thereof, along the route. The one or more detected wireless signals may include one or more wireless signals detected from at least one of an access point, a base station, or a wireless device. In some aspects, the device (e.g., device 1202) may receive an indication of the at least one of the motion pattern or the environmental pattern expected along the route. The at least one of the expected motion pattern or the expected environmental pattern may include at least one of a crowdsourced motion pattern or a crowdsourced environmental pattern along the route. Also, the motion information of the device may be obtained through at least one of an inertial measurement unit (IMU), a gyroscope, or one or more accelerometers, and where the environmental information associated with the device is obtained through one or more sensors or receivers at the device configured to sense or receive the environmental information.

At 1232, device 1202 may obtain, along the route of the device, at least one of motion information of one or more other devices or environmental information associated with the one or more other devices. In some aspects, the motion information of one or more other devices or the environmental information of one or more other devices may be obtained from the one or more other devices or the server 1204.

At 1240, device 1202 may determine, based on a comparison of the obtained information with the at least one of the expected motion pattern of the device or the expected environmental pattern of the device along the route, that the obtained information is inconsistent with the at least one of the expected motion pattern of the device or the expected environmental pattern of the device along the route. In some aspects, the determination that obtained information is inconsistent with at least one of an expected motion pattern of the device or an expected environmental pattern of the device along the route may be based on at least one of motion information of the device or environmental information associated with the device deviating by a threshold from at least one of the motion information of the one or more other devices or the environmental information associated with the one or more other devices. In some instances, the determination that the obtained information is inconsistent with the at least one of the expected motion pattern of the device or the expected environmental pattern of the device along the route may be based on a comparison between the at least one of the motion information of the device or the environmental information associated with the device and the at least one of the motion information of the one or more other devices or the environmental information associated with the one or more other devices. Also, the determination that the obtained information is inconsistent with the at least one of the expected motion pattern of the device or the expected environmental pattern of the device along the route may be based on at least one of: a difference between the obtained information and the at least one of the expected motion pattern of the device or the expected environmental pattern of the device along the route being greater than a threshold; or the obtained information being unexpected based on the expected motion pattern of the device or the expected environmental pattern of the device along the route. In some aspects, the transmitted information may include an indication of at least one of: the obtained motion information that is inconsistent with the expected motion pattern along the route; the obtained environmental information that is inconsistent with the expected environmental pattern along the route; a location along the route at which the obtained information is inconsistent with the at least one of the expected motion pattern of the device or the expected environmental pattern of the device; an extrapolated absolute or relative position of the device; images captured by the device; or one or more access points, one or more base stations, or one or more wireless devices detected by the device upon the determination that the obtained information is inconsistent with the at least one of the expected motion pattern of the device or the expected environmental pattern of the device along the route. The one or more access points, the one or more base stations, or the one or more wireless devices detected by the device may be unexpected based on the at least one of the expected motion pattern of the device or the expected environmental pattern of the device along the route. In some aspects, the determination that the obtained information is inconsistent with the at least one of the expected motion pattern of the device or the expected environmental pattern of the device along the route may be based on comparing different types of obtained information during different segments between waypoints along the route with a corresponding expected motion pattern of the device or a corresponding expected environmental pattern of the device.

At 1250, device 1202 may transmit, when the obtained information is inconsistent with at least one of an expected motion pattern of the device or an expected environmental pattern of the device along the route, information (e.g., information 1254) indicating that the obtained at least one of the motion information or the environmental information is inconsistent with the at least one of the expected motion pattern of the device or the expected environmental pattern of the device along the route. The information indicating that the obtained at least one of the motion information or the environmental information is inconsistent with the at least one of the expected motion pattern of the device or the expected environmental pattern of the device along the route may be transmitted one of: at preconfigured times after the determination that the obtained information is inconsistent with the at least one of the expected motion pattern of the device or the expected environmental pattern of the device along the route; after a preconfigured time or estimated distance traveled upon the determination that the obtained information is inconsistent with the at least one of the expected motion pattern of the device or the expected environmental pattern of the device along the route; or at a time upon successfully connecting to a network. The transmitted information may be encrypted based on at least one of a public key or a private key.

At 1252, server 1204 may receive, based on the configuration, information from the device (e.g., receive information 1254 from device 1202) indicating that at least one of motion information at the device or environmental information associated with the device is inconsistent with the configured at least one of the expected motion pattern of the device or the expected environmental pattern of the device along the route. Also, server 1204 may receive second information (e.g., receive information 1262 from device 1202) indicating that at least one of the motion information or the environmental information corresponds with the at least one of the expected motion pattern or the expected environmental pattern. The received information may be encrypted based on at least one of the public key or the private key. The motion information may include at least one of a velocity, acceleration, directional changes, or elevation changes at the device, and the expected motion pattern may include at least one of an expected velocity pattern, an expected acceleration pattern, an expected directional change pattern, an expected elevation change pattern, or any combination thereof, at the device along the route. The environmental information associated with the device may include at least one of a temperature, a humidity, a pressure, one or more detected wireless signals, electromagnetic radiation, an electromagnetic field at the device, or any combination thereof, and the expected environmental pattern may include at least one of an expected temperature pattern, an expected humidity pattern, an expected pressure pattern, an expected detected wireless signal pattern, an expected electromagnetic radiation pattern, an expected electromagnetic field pattern, or any combination thereof, at the device along the route. The received information may indicate at least one of route deviation information of the device from the route, absolute or relative position information of the device, device information associated with at least one of a detected access point, base station, or wireless device, or any combination thereof. The received information includes an indication of at least one of: the motion information that is inconsistent with the expected motion pattern along the route; the environmental information that is inconsistent with the expected environmental pattern along the route; a location along the route at which the at least one of the motion information or the environmental information is inconsistent with the at least one of the expected motion pattern of the device or the expected environmental pattern of the device; an extrapolated absolute or relative position of the device; images captured by the device; or one or more access points, base stations, or wireless devices detected by the device.

At 1260, device 1202 may transmit, when the obtained information is consistent with at least one of the expected motion pattern of the device or the expected environmental pattern of the device along the route, second information (e.g., information 1262) indicating that the obtained at least one of the motion information or the environmental information corresponds with the at least one of the expected motion pattern of the device or the expected environmental pattern of the device along the route.

At 1270, device 1202 may obtain, upon the determination that the obtained information is inconsistent with the at least one of the expected motion pattern of the device or the expected environmental pattern of the device along the route, at least one of route deviation information of the device, absolute or relative position information of the device, device information associated with at least one of a detected access point, a detected base station, or a detected wireless device, or any combination thereof, where the transmitted information indicates the at least one of the route deviation information of the device, the absolute or relative position information of the device, the device information associated with the at least one of the detected access point, the detected base station, or the detected wireless device, or any combination thereof.

At 1272, server 1204 may determine, based on the received information from the device, at least one of the device has been compromised or stolen based on the received at least one of the motion information or the environmental information.

At 1280, server 1204 may modify the at least one of the expected motion pattern or the expected environmental pattern along the route based on machine learning and received second information indicating the at least one of the motion pattern or the environmental pattern experienced by additional devices along the route.

At 1290, device 1202 may initiate a wake-up state of the device when the obtained at least one of the motion information or the environmental information is consistent with the at least one of the expected motion pattern of the device or the expected environmental pattern of the device along the route. Also, at 1290, device 1202 may transmit, during the wake-up state of the device, an indication of at least one of: (1) one or more access points, one or more base stations, or one or more wireless devices along the route, or (2) the device passed one or more predefined locations along the route.

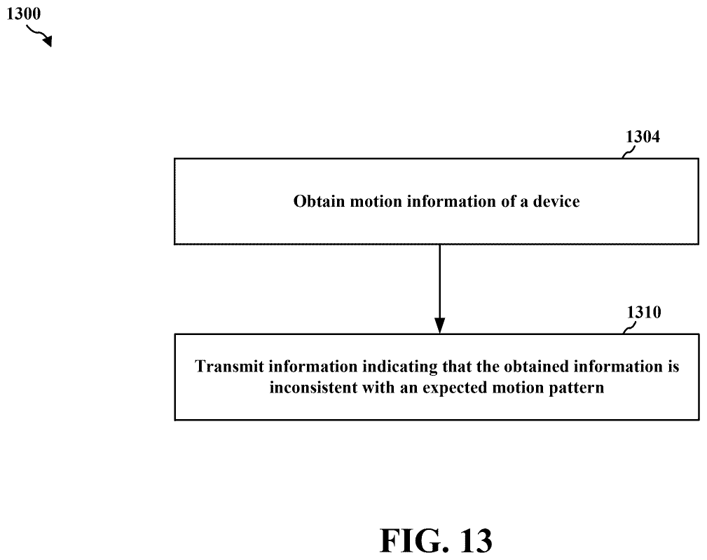

FIG. 13 is a flowchart 1300 of a method of wireless communication. The method may be performed by a device or a UE (e.g., the UE 104, device 702, device 802, device 902, device 1002, device 1102, device 1202; the apparatus 1904). The methods described herein may provide a number of benefits, such as improving resource utilization and/or power savings.

At 1304, the device may obtain, along a route of the device, motion information of the device, as discussed with respect to FIGS. 4-12. For example, as described in 1230 of FIG. 12, the device 1202 may obtain, along a route of the device, motion information of the device. Further, step 1304 may be performed by information component 198. In some aspects, the motion information of the device may be obtained from the device, a server (e.g., a cloud server, a third party server, an edge server, a network, or a network entity), or other devices. The motion information may include at least one of a velocity, acceleration, directional changes, elevation changes, or any combination thereof, and the expected motion pattern includes at least one of an expected velocity pattern, an expected acceleration pattern, an expected directional change pattern, an expected elevation change pattern, or any combination thereof, along the route. The one or more detected wireless signals may include one or more wireless signals detected from at least one of an access point, a base station, or a wireless device. In some aspects, the device may receive an indication of the motion pattern along the route. The expected motion pattern o may include at least one of a crowdsourced motion pattern along the route. Also, the motion information of the device may be obtained through at least one of an inertial measurement unit (IMU), a gyroscope, or one or more accelerometers.

At 1310, the device may transmit, when the obtained information is inconsistent with at least one of an expected motion pattern of the device along the route, information indicating that the obtained motion information is inconsistent with the at least one of the expected motion pattern of the device along the route, as discussed with respect to FIGS. 4-12. For example, as described in 1250 of FIG. 12, the device 1202 may transmit, when the obtained information is inconsistent with an expected motion pattern of the device along the route, information indicating that the obtained motion information is inconsistent with the expected motion pattern of the device along the route. Further, step 1310 may be performed by information component 198. The information indicating that the obtained motion information is inconsistent with the expected motion pattern of the device along the route may be transmitted one of: at preconfigured times after the determination that the obtained information is inconsistent with the expected motion pattern of the device along the route; after a preconfigured time or estimated distance traveled upon the determination that the obtained information is inconsistent with the expected motion pattern of the device along the route; or at a time upon successfully connecting to a network. The transmitted information may be encrypted based on at least one of a public key or a private key.

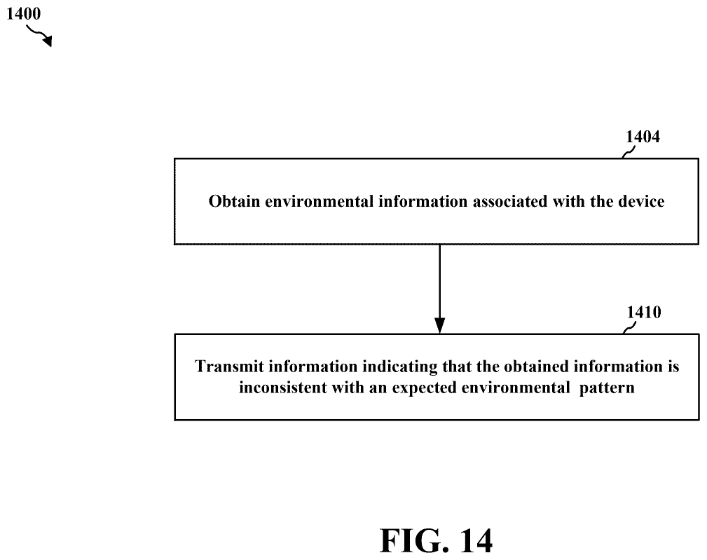

FIG. 14 is a flowchart 1400 of a method of wireless communication. The method may be performed by a device or a UE (e.g., the UE 104, device 702, device 802, device 902, device 1002, device 1102, device 1202; the apparatus 1904). The methods described herein may provide a number of benefits, such as improving resource utilization and/or power savings.

At 1404, the device may obtain, along a route of the device, environmental information associated with the device, as discussed with respect to FIGS. 4-12. For example, as described in 1230 of FIG. 12, the device 1202 may obtain, along a route of the device, environmental information associated with the device. Further, step 1404 may be performed by information component 198. In some aspects, the environmental information of the device may be obtained from the device, a server (e.g., a cloud server, a third party server, an edge server, a network, or a network entity), or other devices. The environmental information may include at least one of a temperature, a humidity, a pressure, one or more detected wireless signals, electromagnetic radiation, an electromagnetic field, or any combination thereof, and the expected environmental pattern includes at least one of an expected temperature pattern, an expected humidity pattern, an expected pressure pattern, an expected detected wireless signal pattern, an expected electromagnetic radiation pattern, an expected electromagnetic field pattern, or any combination thereof, along the route. The one or more detected wireless signals may include one or more wireless signals detected from at least one of an access point, a base station, or a wireless device. In some aspects, the device may receive an indication of the environmental pattern expected along the route. The expected environmental pattern may include a crowdsourced environmental pattern along the route. Also, the environmental information associated with the device is obtained through one or more sensors or receivers at the device configured to sense or receive the environmental information.

At 1410, the device may transmit, when the obtained information is inconsistent with an expected environmental pattern of the device along the route, information indicating that the obtained environmental information is inconsistent with the expected environmental pattern of the device along the route, as discussed with respect to FIGS. 4-12. For example, as described in 1250 of FIG. 12, the device 1202 may transmit, when the obtained information is inconsistent with an expected environmental pattern of the device along the route, information indicating that the obtained environmental information is inconsistent with expected environmental pattern of the device along the route. Further, step 1410 may be performed by information component 198. The information indicating that the obtained environmental information is inconsistent with expected environmental pattern of the device along the route may be transmitted one of: at preconfigured times after the determination that the obtained information is inconsistent with the expected environmental pattern of the device along the route; after a preconfigured time or estimated distance traveled upon the determination that the obtained information is inconsistent with the expected environmental pattern of the device along the route; or at a time upon successfully connecting to a network. The transmitted information may be encrypted based on at least one of a public key or a private key.

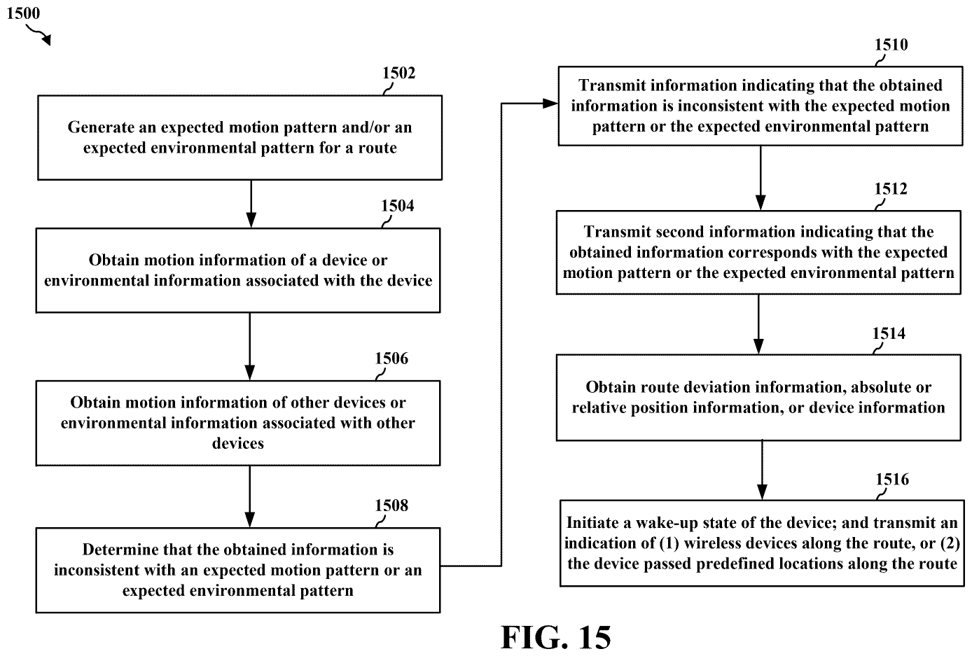

FIG. 15 is a flowchart 1500 of a method of wireless communication. The method may be performed by a device or a UE (e.g., the UE 104, device 702, device 802, device 902, device 1002, device 1102, device 1202; the apparatus 1904). The methods described herein may provide a number of benefits, such as improving resource utilization and/or power savings.

At 1502, the device may generate at least one of an expected motion pattern of a device or an expected environmental pattern of the device for a route based on at least one of motion information of one or more other devices or environmental information associated with the one or more other devices, as discussed with respect to FIGS. 4-12. For example, as described in 1210 of FIG. 12, the device 1202 may generate at least one of an expected motion pattern of a device or an expected environmental pattern of the device for a route based on at least one of motion information of one or more other devices or environmental information associated with the one or more other devices. Further, step 1502 may be performed by information component 198.

At 1504, the device may obtain, along a route of the device, at least one of motion information of the device or environmental information associated with the device, as discussed with respect to FIGS. 4-12. For example, as described in 1230 of FIG. 12, the device 1202 may obtain, along a route of the device, at least one of motion information of the device or environmental information associated with the device. Further, step 1504 may be performed by information component 198. In some aspects, the motion information of the device or the environmental information of the device may be obtained from the device, a server (e.g., a cloud server, a third party server, an edge server, a network, or a network entity), or other devices. The motion information may include at least one of a velocity, acceleration, directional changes, elevation changes, or any combination thereof, and the expected motion pattern includes at least one of an expected velocity pattern, an expected acceleration pattern, an expected directional change pattern, an expected elevation change pattern, or any combination thereof, along the route. The environmental information may include at least one of a temperature, a humidity, a pressure, one or more detected wireless signals, electromagnetic radiation, an electromagnetic field, or any combination thereof, and the expected environmental pattern includes at least one of an expected temperature pattern, an expected humidity pattern, an expected pressure pattern, an expected detected wireless signal pattern, an expected electromagnetic radiation pattern, an expected electromagnetic field pattern, or any combination thereof, along the route. The one or more detected wireless signals may include one or more wireless signals detected from at least one of an access point, a base station, or a wireless device. In some aspects, the device may receive an indication of the at least one of the motion pattern or the environmental pattern expected along the route. The at least one of the expected motion pattern or the expected environmental pattern may include at least one of a crowdsourced motion pattern or a crowdsourced environmental pattern along the route. Also, the motion information of the device may be obtained through at least one of an inertial measurement unit (IMU), a gyroscope, or one or more accelerometers, and where the environmental information associated with the device is obtained through one or more sensors or receivers at the device configured to sense or receive the environmental information.

At 1506, the device may obtain, along the route of the device, at least one of motion information of one or more other devices or environmental information associated with the one or more other devices, as discussed with respect to FIGS. 4-12. For example, as described in 1232 of FIG. 12, the device 1202 may obtain, along the route of the device, at least one of motion information of one or more other devices or environmental information associated with the one or more other devices. Further, step 1506 may be performed by information component 198. In some aspects, the motion information of one or more other devices or the environmental information of one or more other devices may be obtained from the one or more other devices or a server.

At 1508, the device may determine, based on a comparison of the obtained information with the at least one of the expected motion pattern of the device or the expected environmental pattern of the device along the route, that the obtained information is inconsistent with the at least one of the expected motion pattern of the device or the expected environmental pattern of the device along the route, as discussed with respect to FIGS. 4-12. For example, as described in 1240 of FIG. 12, the device 1202 may determine, based on a comparison of the obtained information with the at least one of the expected motion pattern of the device or the expected environmental pattern of the device along the route, that the obtained information is inconsistent with the at least one of the expected motion pattern of the device or the expected environmental pattern of the device along the route. Further, step 1508 may be performed by information component 198. In some aspects, the determination that obtained information is inconsistent with at least one of an expected motion pattern of the device or an expected environmental pattern of the device along the route may be based on at least one of motion information of the device or environmental information associated with the device deviating by a threshold from at least one of the motion information of the one or more other devices or the environmental information associated with the one or more other devices. In some instances, the determination that the obtained information is inconsistent with the at least one of the expected motion pattern of the device or the expected environmental pattern of the device along the route may be based on a comparison between the at least one of the motion information of the device or the environmental information associated with the device and the at least one of the motion information of the one or more other devices or the environmental information associated with the one or more other devices. Also, the determination that the obtained information is inconsistent with the at least one of the expected motion pattern of the device or the expected environmental pattern of the device along the route may be based on at least one of: a difference between the obtained information and the at least one of the expected motion pattern of the device or the expected environmental pattern of the device along the route being greater than a threshold; or the obtained information being unexpected based on the expected motion pattern of the device or the expected environmental pattern of the device along the route. In some aspects, the transmitted information may include an indication of at least one of: the obtained motion information that is inconsistent with the expected motion pattern along the route; the obtained environmental information that is inconsistent with the expected environmental pattern along the route; a location along the route at which the obtained information is inconsistent with the at least one of the expected motion pattern of the device or the expected environmental pattern of the device; an extrapolated absolute or relative position of the device; images captured by the device; or one or more access points, one or more base stations, or one or more wireless devices detected by the device upon the determination that the obtained information is inconsistent with the at least one of the expected motion pattern of the device or the expected environmental pattern of the device along the route. The one or more access points, the one or more base stations, or the one or more wireless devices detected by the device may be unexpected based on the at least one of the expected motion pattern of the device or the expected environmental pattern of the device along the route. In some aspects, the determination that the obtained information is inconsistent with the at least one of the expected motion pattern of the device or the expected environmental pattern of the device along the route may be based on comparing different types of obtained information during different segments between waypoints along the route with a corresponding expected motion pattern of the device or a corresponding expected environmental pattern of the device.

At 1510, the device may transmit, when the obtained information is inconsistent with at least one of an expected motion pattern of the device or an expected environmental pattern of the device along the route, information indicating that the obtained at least one of the motion information or the environmental information is inconsistent with the at least one of the expected motion pattern of the device or the expected environmental pattern of the device along the route, as discussed with respect to FIGS. 4-12. For example, as described in 1250 of FIG. 12, the device 1202 may transmit, when the obtained information is inconsistent with at least one of an expected motion pattern of the device or an expected environmental pattern of the device along the route, information indicating that the obtained at least one of the motion information or the environmental information is inconsistent with the at least one of the expected motion pattern of the device or the expected environmental pattern of the device along the route. Further, step 1510 may be performed by information component 198. The information indicating that the obtained at least one of the motion information or the environmental information is inconsistent with the at least one of the expected motion pattern of the device or the expected environmental pattern of the device along the route may be transmitted one of: at preconfigured times after the determination that the obtained information is inconsistent with the at least one of the expected motion pattern of the device or the expected environmental pattern of the device along the route; after a preconfigured time or estimated distance traveled upon the determination that the obtained information is inconsistent with the at least one of the expected motion pattern of the device or the expected environmental pattern of the device along the route; or at a time upon successfully connecting to a network. The transmitted information may be encrypted based on at least one of a public key or a private key.

At 1512, the device may transmit, when the obtained information is consistent with at least one of the expected motion pattern of the device or the expected environmental pattern of the device along the route, second information indicating that the obtained at least one of the motion information or the environmental information corresponds with the at least one of the expected motion pattern of the device or the expected environmental pattern of the device along the route, as discussed with respect to FIGS. 4-12. For example, as described in 1260 of FIG. 12, the device 1202 may transmit, when the obtained information is consistent with at least one of the expected motion pattern of the device or the expected environmental pattern of the device along the route, second information indicating that the obtained at least one of the motion information or the environmental information corresponds with the at least one of the expected motion pattern of the device or the expected environmental pattern of the device along the route. Further, step 1512 may be performed by information component 198.

At 1514, the device may obtain, upon the determination that the obtained information is inconsistent with the at least one of the expected motion pattern of the device or the expected environmental pattern of the device along the route, at least one of route deviation information of the device, absolute or relative position information of the device, device information associated with at least one of a detected access point, a detected base station, or a detected wireless device, or any combination thereof, where the transmitted information indicates the at least one of the route deviation information of the device, the absolute or relative position information of the device, the device information associated with the at least one of the detected access point, the detected base station, or the detected wireless device, or any combination thereof, as discussed with respect to FIGS. 4-12. For example, as described in 1270 of FIG. 12, the device 1202 may obtain, upon the determination that the obtained information is inconsistent with the at least one of the expected motion pattern of the device or the expected environmental pattern of the device along the route, at least one of route deviation information of the device, absolute or relative position information of the device, device information associated with at least one of a detected access point, a detected base station, or a detected wireless device, or any combination thereof, where the transmitted information indicates the at least one of the route deviation information of the device, the absolute or relative position information of the device, the device information associated with the at least one of the detected access point, the detected base station, or the detected wireless device, or any combination thereof. Further, step 1514 may be performed by information component 198.

At 1516, the device may initiate a wake-up state of the device when the obtained at least one of the motion information or the environmental information is consistent with the at least one of the expected motion pattern of the device or the expected environmental pattern of the device along the route, as discussed with respect to FIGS. 4-12. For example, as described in 1290 of FIG. 12, the device 1202 may initiate a wake-up state of the device when the obtained at least one of the motion information or the environmental information is consistent with the at least one of the expected motion pattern of the device or the expected environmental pattern of the device along the route. Also, at 1516, the device may transmit, during the wake-up state of the device, an indication of at least one of: (1) one or more access points, one or more base stations, or one or more wireless devices along the route, or (2) the device passed one or more predefined locations along the route, as discussed with respect to FIGS. 4-12. For example, as described in 1290 of FIG. 12, the device 1202 may transmit, during the wake-up state of the device, an indication of at least one of: (1) one or more access points, one or more base stations, or one or more wireless devices along the route, or (2) the device passed one or more predefined locations along the route. Further, step 1516 may be performed by information component 198.

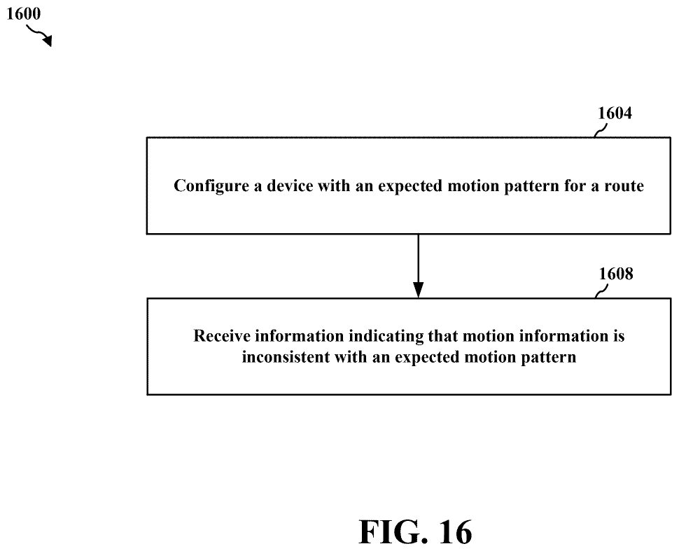

FIG. 16 is a flowchart 1600 of a method of wireless communication. The method may be performed by a server (e.g., server 1204, a cloud server, a third party server, an edge server, etc.) or a network entity (e.g., LMF 166; network entity 2160) or a base station (e.g., the base station 102; the network entity 2002). The methods described herein may provide a number of benefits, such as improving resource utilization and/or power savings.

At 1604, the server may configure a device with an expected motion pattern of the device along a route, as discussed with respect to FIGS. 4-12. For example, as described in 1220 of FIG. 12, the server 1204 may configure a device with an expected motion pattern of the device along a route. Further, step 1604 may be performed by information component 199. For example, the server may transmit a configuration to a device in order to configure the device with an expected motion pattern of the device along a route. Likewise, the device may receive a configuration from the server in order to configure the device with an expected motion pattern of the device along a route. Also, the configured expected motion pattern of the device along the route may indicate different types of motion information that should be obtained by the device during different segments between waypoints along the route for comparison with the expected motion pattern of the device.

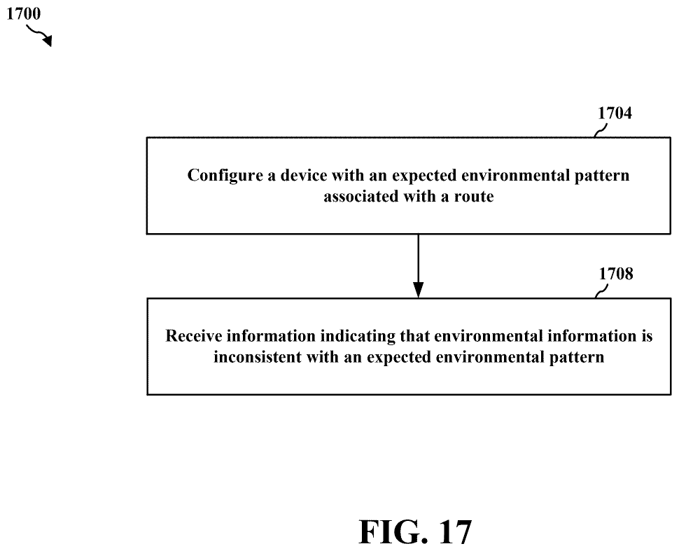

At 1608, the server may receive, based on the configuration, information from the device indicating that motion information at the device is inconsistent with the configured expected motion pattern of the device along the route, as discussed with respect to FIGS. 4-12. For example, as described in 1252 of FIG. 12, the server 1204 may receive, based on the configuration, information from the device indicating that motion information at the device is inconsistent with the configured expected motion pattern of the device along the route. Further, step 1608 may be performed by information component 199. Also, the server may receive second information indicating that the motion information corresponds with the expected motion pattern. The received information may be encrypted based on at least one of the public key or the private key. The motion information may include at least one of a velocity, acceleration, directional changes, or elevation changes at the device, and the expected motion pattern may include at least one of an expected velocity pattern, an expected acceleration pattern, an expected directional change pattern, an expected elevation change pattern, or any combination thereof, at the device along the route. The received information may indicate at least one of route deviation information of the device from the route, absolute or relative position information of the device, device information associated with at least one of a detected access point, base station, or wireless device, or any combination thereof. The received information includes an indication of at least one of: the motion information that is inconsistent with the expected motion pattern along the route; a location along the route at which the motion information is inconsistent with the expected motion pattern of the device; an extrapolated absolute or relative position of the device; images captured by the device; or one or more access points, base stations, or wireless devices detected by the device. FIG. 17 is a flowchart 1700 of a method of wireless communication. The method may be performed by a server (e.g., server 1204, a cloud server, a third party server, an edge server, etc.) or a network entity (e.g., LMF 166; network entity 2160) or a base station (e.g., the base station 102; the network entity 2002). The methods described herein may provide a number of benefits, such as improving resource utilization and/or power savings.

At 1704, the server may configure a device with an expected environmental pattern of the device along a route, as discussed with respect to FIGS. 4-12. For example, as described in 1220 of FIG. 12, the server 1204 may configure a device with an expected environmental pattern of the device along a route. Further, step 1704 may be performed by information component 199. For example, the server may transmit a configuration to a device in order to configure the device with an expected environmental pattern of the device along a route. Likewise, the device may receive a configuration from the server in order to configure the device with an expected environmental pattern of the device along a route. Also, the configured expected environmental pattern of the device along the route may indicate different types of environmental information that should be obtained by the device during different segments between waypoints along the route for comparison with the expected environmental pattern of the device.

At 1708, the server may receive, based on the configuration, information from the device indicating that environmental information associated with the device is inconsistent with the configured expected environmental pattern of the device along the route, as discussed with respect to FIGS. 4-12. For example, as described in 1252 of FIG. 12, the server 1204 may receive, based on the configuration, information from the device indicating that environmental information associated with the device is inconsistent with the configured expected environmental pattern of the device along the route. Further, step 1708 may be performed by information component 199. Also, the server may receive second information indicating that the environmental information corresponds with the expected environmental pattern. The received information may be encrypted based on at least one of the public key or the private key. The environmental information associated with the device may include at least one of a temperature, a humidity, a pressure, one or more detected wireless signals, electromagnetic radiation, an electromagnetic field at the device, or any combination thereof, and the expected environmental pattern may include at least one of an expected temperature pattern, an expected humidity pattern, an expected pressure pattern, an expected detected wireless signal pattern, an expected electromagnetic radiation pattern, an expected electromagnetic field pattern, or any combination thereof, at the device along the route. The received information may indicate at least one of route deviation information of the device from the route, absolute or relative position information of the device, device information associated with at least one of a detected access point, base station, or wireless device, or any combination thereof. The received information includes an indication of at least one of: the environmental information that is inconsistent with the expected environmental pattern along the route; a location along the route at which the environmental information is inconsistent with the expected environmental pattern of the device; an extrapolated absolute or relative position of the device; images captured by the device; or one or more access points, base stations, or wireless devices detected by the device.

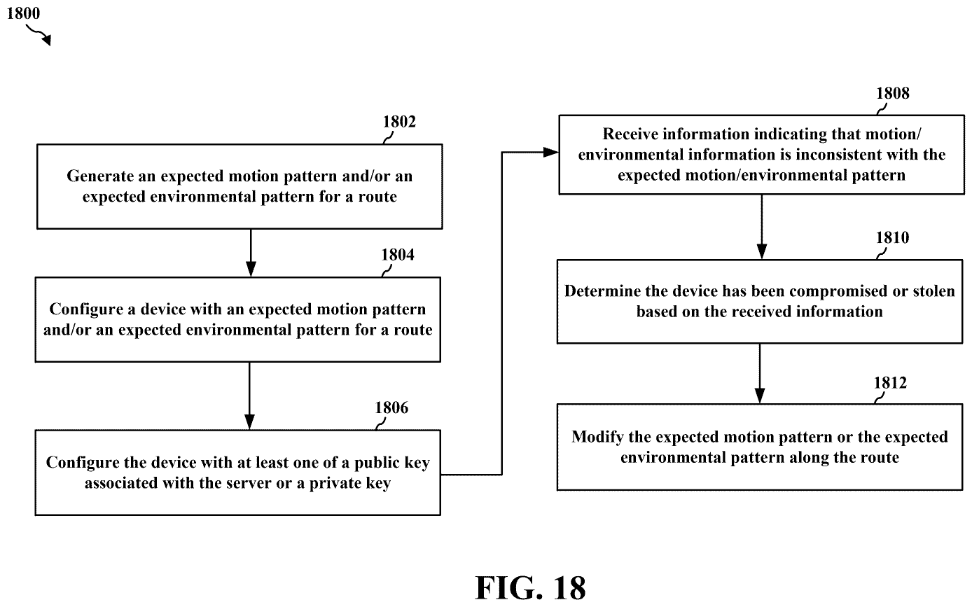

FIG. 18 is a flowchart 1800 of a method of wireless communication. The method may be performed by a server (e.g., server 1204, a cloud server, a third party server, an edge server, etc.) or a network entity (e.g., LMF 166; network entity 2160) or a base station (e.g., the base station 102; the network entity 2002). The methods described herein may provide a number of benefits, such as improving resource utilization and/or power savings.

At 1802, the server may generate at least one of an expected motion pattern or an expected environmental pattern along a route based on received crowdsourced information indicating at least one of motion pattern or environmental pattern along the route, as discussed with respect to FIGS. 4-12. For example, as described in 1212 of FIG. 12, the server 1204 may generate at least one of an expected motion pattern or an expected environmental pattern along a route based on received crowdsourced information indicating at least one of motion pattern or environmental pattern along the route. Further, step 1802 may be performed by information component 199.

At 1804, the server may configure a device with at least one of an expected motion pattern of the device or an expected environmental pattern of the device along a route, as discussed with respect to FIGS. 4-12. For example, as described in 1220 of FIG. 12, the server 1204 may configure a device with at least one of an expected motion pattern of the device or an expected environmental pattern of the device along a route. Further, step 1804 may be performed by information component 199. For example, the server may transmit a configuration to a device in order to configure the device with at least one of an expected motion pattern of the device or an expected environmental pattern of the device along a route. Likewise, the device may receive a configuration from the server in order to configure the device with at least one of an expected motion pattern of the device or an expected environmental pattern of the device along a route. Also, the configured at least one of the expected motion pattern of the device or the expected environmental pattern of the device along the route may indicate different types of motion information or different types of environmental information that should be obtained by the device during different segments between waypoints along the route for comparison with the expected motion pattern of the device or the expected environmental pattern of the device.

At 1806, the server may configure the device with at least one of a public key associated with the server or a private key, where received information may be encrypted based on at least one of the public key or the private key, as discussed with respect to FIGS. 4-12. For example, as described in 1222 of FIG. 12, the server 1204 may configure the device with at least one of a public key associated with the server or a private key, where received information may be encrypted based on at least one of the public key or the private key. Further, step 1806 may be performed by information component 199. For example, the server may transmit a configuration to a device in order to configure the device with at least one of a public key associated with the server or a private key. Likewise, the device may receive a configuration from the server in order to configure the device with at least one of a public key associated with the server or a private key.

At 1808, the server may receive, based on the configuration, information from the device indicating that at least one of motion information at the device or environmental information associated with the device is inconsistent with the configured at least one of the expected motion pattern of the device or the expected environmental pattern of the device along the route, as discussed with respect to FIGS. 4-12. For example, as described in 1252 of FIG. 12, the server 1204 may receive, based on the configuration, information from the device indicating that at least one of motion information at the device or environmental information associated with the device is inconsistent with the configured at least one of the expected motion pattern of the device or the expected environmental pattern of the device along the route. Further, step 1808 may be performed by information component 199. Also, the server may receive second information indicating that at least one of the motion information or the environmental information corresponds with the at least one of the expected motion pattern or the expected environmental pattern. The received information may be encrypted based on at least one of the public key or the private key. The motion information may include at least one of a velocity, acceleration, directional changes, or elevation changes at the device, and the expected motion pattern may include at least one of an expected velocity pattern, an expected acceleration pattern, an expected directional change pattern, an expected elevation change pattern, or any combination thereof, at the device along the route. The environmental information associated with the device may include at least one of a temperature, a humidity, a pressure, one or more detected wireless signals, electromagnetic radiation, an electromagnetic field at the device, or any combination thereof, and the expected environmental pattern may include at least one of an expected temperature pattern, an expected humidity pattern, an expected pressure pattern, an expected detected wireless signal pattern, an expected electromagnetic radiation pattern, an expected electromagnetic field pattern, or any combination thereof, at the device along the route. The received information may indicate at least one of route deviation information of the device from the route, absolute or relative position information of the device, device information associated with at least one of a detected access point, base station, or wireless device, or any combination thereof. The received information includes an indication of at least one of: the motion information that is inconsistent with the expected motion pattern along the route; the environmental information that is inconsistent with the expected environmental pattern along the route; a location along the route at which the at least one of the motion information or the environmental information is inconsistent with the at least one of the expected motion pattern of the device or the expected environmental pattern of the device; an extrapolated absolute or relative position of the device; images captured by the device; or one or more access points, base stations, or wireless devices detected by the device.

At 1810, the server may determine, based on the received information from the device, at least one of the device has been compromised or stolen based on the received at least one of the motion information or the environmental information, as discussed with respect to FIGS. 4-12. For example, as described in 1272 of FIG. 12, the server 1204 may determine, based on the received information from the device, at least one of the device has been compromised or stolen based on the received at least one of the motion information or the environmental information. Further, step 1810 may be performed by information component 199.

At 1812, the server may modify the at least one of the expected motion pattern or the expected environmental pattern along the route based on machine learning and received second information indicating the at least one of the motion pattern or the environmental pattern experienced by additional devices along the route, as discussed with respect to FIGS. 4-12. For example, as described in 1280 of FIG. 12, the server 1204 may modify the at least one of the expected motion pattern or the expected environmental pattern along the route based on machine learning and received second information indicating the at least one of the motion pattern or the environmental pattern experienced by additional devices along the route. Further, step 1812 may be performed by information component 199.

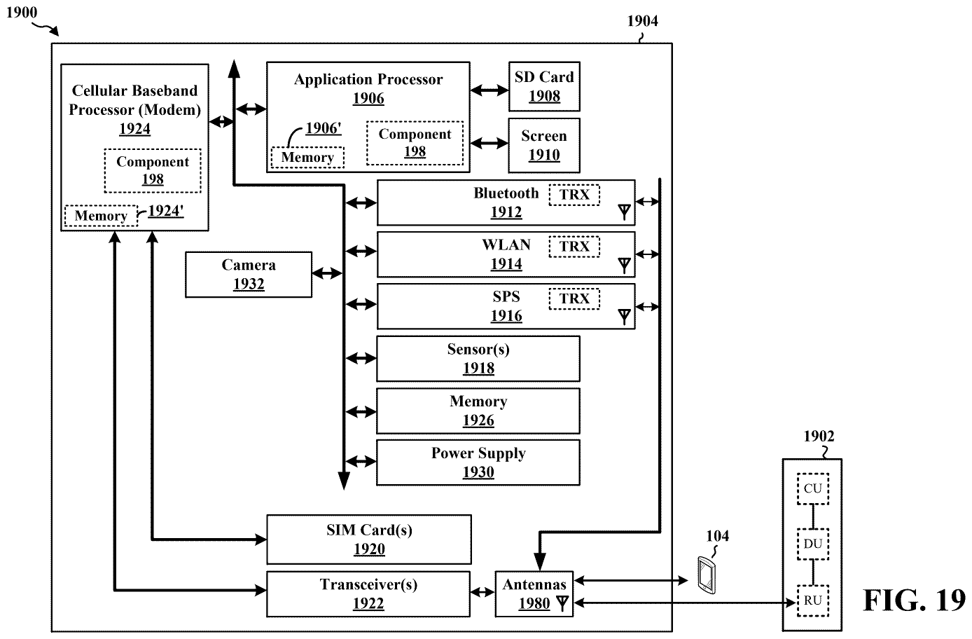

FIG. 19 is a diagram 1900 illustrating an example of a hardware implementation for an apparatus 1904. The apparatus 1904 may be a device, a wireless device, a UE, a component of a UE, or may implement UE functionality. In some aspects, the apparatus 1904 may include a cellular baseband processor 1924 (also referred to as a modem) coupled to one or more transceivers 1922 (e.g., cellular RF transceiver). The cellular baseband processor 1924 may include on-chip memory 1924′. In some aspects, the apparatus 1904 may further include one or more subscriber identity modules (SIM) cards 1920 and an application processor 1906 coupled to a secure digital (SD) card 1908 and a screen 1910. The application processor 1906 may include on-chip memory 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the WLAN module 1914, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize the antennas 1980 for communication. The cellular baseband processor 1924 communicates through the transceiver(s) 1922 via one or more antennas 1980 with the UE 104 and/or with an RU associated with a network entity 1902. The cellular baseband processor 1924 and the application processor 1906 may each include a computer-readable medium/memory 1924′, 1906′, respectively. The additional memory modules 1926 may also be considered a computer-readable medium/memory. Each computer-readable medium/memory 1924′, 1906′, 1926 may be non-transitory. The cellular baseband processor 1924 and the application processor 1906 are each responsible for general processing, including the execution of software stored on the computer-readable medium/memory. The software, when executed by the cellular baseband processor 1924/application processor 1906, causes the cellular baseband processor 1924/application processor 1906 to perform the various functions described supra. The computer-readable medium/memory may also be used for storing data that is manipulated by the cellular baseband processor 1924/application processor 1906 when executing software. The cellular baseband processor 1924/application processor 1906 may be a component of the UE 350 and may include the memory 360 and/or at least one of the TX processor 368, the RX processor 356, and the controller/processor 359. In one configuration, the apparatus 1904 may be a processor chip (modem and/or application) and include just the cellular baseband processor 1924 and/or the application processor 1906, and in another configuration, the apparatus 1904 may be the entire UE (e.g., see 350 of FIG. 3) and include the additional modules of the apparatus 1904.

As discussed supra, the information component 198 may be configured to obtain, along a route of the device, at least one of motion information of the device or environmental information associated with the device. The information component 198 may also be configured to transmit, when the obtained information is inconsistent with at least one of an expected motion pattern of the device or an expected environmental pattern of the device along the route, information indicating that the obtained at least one of the motion information or the environmental information is inconsistent with the at least one of the expected motion pattern of the device or the expected environmental pattern of the device along the route. The information component 198 may also be configured to determine, based on a comparison of the obtained information with the at least one of the expected motion pattern of the device or the expected environmental pattern of the device along the route, that the obtained information is inconsistent. The information component 198 may also be configured to obtain, upon the determination that the obtained information is inconsistent with the at least one of the expected motion pattern of the device or the expected environmental pattern of the device along the route, at least one of route deviation information of the device, absolute or relative position information of the device, device information associated with at least one of a detected access point, a detected base station, or a detected wireless device, or any combination thereof. The information component 198 may also be configured to generate the at least one of the expected motion pattern of the device or the expected environmental pattern of the device for the route based on at least one of motion information of one or more other devices or environmental information associated with the one or more other devices. The information component 198 may also be configured to obtain, along the route of the device, at least one of motion information of one or more other devices or environmental information associated with the one or more other devices. The information component 198 may also be configured to transmit, when the obtained information is consistent with at least one of the expected motion pattern of the device or the expected environmental pattern of the device along the route, second information indicating that the obtained at least one of the motion information or the environmental information corresponds with the at least one of the expected motion pattern of the device or the expected environmental pattern of the device along the route. The information component 198 may also be configured to initiate a wake-up state of the device when the obtained at least one of the motion information or the environmental information is consistent with the at least one of the expected motion pattern of the device or the expected environmental pattern of the device along the route. The information component 198 may also be configured to transmit, during the wake-up state of the device, an indication of at least one of: (1) one or more access points, one or more base stations, or one or more wireless devices along the route, or (2) the device passed one or more predefined locations along the route. The information component 198 may also be configured to receive an indication of the at least one of the motion pattern or the environmental pattern expected along the route. The information component 198 may be within the cellular baseband processor 1924, the application processor 1906, or both the cellular baseband processor 1924 and the application processor 1906. The information component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1904 may include a variety of components configured for various functions. In one configuration, the apparatus 1904, and in particular the cellular baseband processor 1924 and/or the application processor 1906, includes means for obtaining, along a route of the device, at least one of motion information of the device or environmental information associated with the device. The apparatus 1904 may also include means for transmitting, when the obtained information is inconsistent with at least one of an expected motion pattern of the device or an expected environmental pattern of the device along the route, information indicating that the obtained at least one of the motion information or the environmental information is inconsistent with the at least one of the expected motion pattern of the device or the expected environmental pattern of the device along the route. The apparatus 1904 may also include means for determining, based on a comparison of the obtained information with the at least one of the expected motion pattern of the device or the expected environmental pattern of the device along the route, that the obtained information is inconsistent. The apparatus 1904 may also include means for obtaining, upon the determination that the obtained information is inconsistent with the at least one of the expected motion pattern of the device or the expected environmental pattern of the device along the route, at least one of route deviation information of the device, absolute or relative position information of the device, device information associated with at least one of a detected access point, a detected base station, or a detected wireless device, or any combination thereof. The apparatus 1904 may also include means for generating the at least one of the expected motion pattern of the device or the expected environmental pattern of the device for the route based on at least one of motion information of one or more other devices or environmental information associated with the one or more other devices. The apparatus 1904 may also include means for obtaining, along the route of the device, at least one of motion information of one or more other devices or environmental information associated with the one or more other devices. The apparatus 1904 may also include means for transmitting, when the obtained information is consistent with at least one of the expected motion pattern of the device or the expected environmental pattern of the device along the route, second information indicating that the obtained at least one of the motion information or the environmental information corresponds with the at least one of the expected motion pattern of the device or the expected environmental pattern of the device along the route. The apparatus 1904 may also include means for initiating a wake-up state of the device when the obtained at least one of the motion information or the environmental information is consistent with the at least one of the expected motion pattern of the device or the expected environmental pattern of the device along the route. The apparatus 1904 may also include means for transmitting, during the wake-up state of the device, an indication of at least one of: (1) one or more access points, one or more base stations, or one or more wireless devices along the route, or (2) the device passed one or more predefined locations along the route. The apparatus 1904 may also include means for receiving an indication of the at least one of the motion pattern or the environmental pattern expected along the route. The means may be the information component 198 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

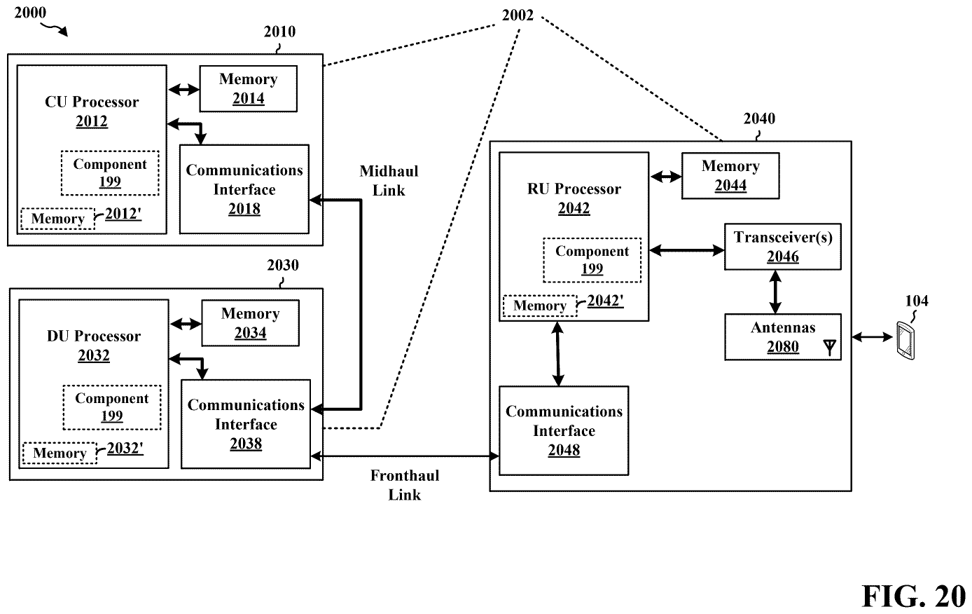

FIG. 20 is a diagram 2000 illustrating an example of a hardware implementation for a network entity 2002. The network entity 2002 may be a server (e.g., a cloud server, a third party server, an edge server, etc.), a BS, a component of a BS, or may implement BS functionality. The network entity 2002 may include at least one of a CU 2010, a DU 2030, or an RU 2040. For example, depending on the layer functionality handled by the information component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include a CU processor 2012. The CU processor 2012 may include on-chip memory 2012′. In some aspects, the CU 2010 may further include additional memory modules 2014 and a communications interface 2018. The CU 2010 communicates with the DU 2030 through a midhaul link, such as an F1 interface. The DU 2030 may include a DU processor 2032. The DU processor 2032 may include on-chip memory 2032′. In some aspects, the DU 2030 may further include additional memory modules 2034 and a communications interface 2038. The DU 2030 communicates with the RU 2040 through a fronthaul link. The RU 2040 may include an RU processor 2042. The RU processor 2042 may include on-chip memory 2042′. In some aspects, the RU 2040 may further include additional memory modules 2044, one or more transceivers 2046, antennas 2080, and a communications interface 2048. The RU 2040 communicates with the UE 104. The on-chip memory 2012′, 2032′, 2042′ and the additional memory modules 2014, 2034, 2044 may each be considered a computer-readable medium/memory. Each computer-readable medium/memory may be non-transitory. Each of the processors 2012, 2032, 2042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the information component 199 may be configured to configure a device with at least one of an expected motion pattern of the device or an expected environmental pattern of the device along a route. The information component 199 may also be configured to receive, based on the configuration, information from the device indicating that at least one of motion information at the device or environmental information associated with the device is inconsistent with the configured at least one of the expected motion pattern of the device or the expected environmental pattern of the device along the route. The information component 199 may also be configured to determine, based on the received information from the device, at least one of the device has been compromised or stolen based on the received at least one of the motion information or the environmental information. The information component 199 may also be configured to generate the at least one of the expected motion pattern or the expected environmental pattern along the route based on received crowdsourced information indicating the at least one of the motion pattern or the environmental pattern along the route. The information component 199 may also be configured to modify the at least one of the expected motion pattern or the expected environmental pattern along the route based on machine learning and received second information indicating the at least one of the motion pattern or the environmental pattern experienced by additional devices along the route. The information component 199 may also be configured to configure the device with at least one of a public key associated with the server or a private key.

The information component 199 may be within one or more processors of one or more of the CU 2010, DU 2030, and the RU 2040. The information component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2002 may include a variety of components configured for various functions. In one configuration, the network entity 2002 may include means for configuring a device with at least one of an expected motion pattern of the device or an expected environmental pattern of the device along a route. The network entity 2002 may also include means for receiving, based on the configuration, information from the device indicating that at least one of motion information at the device or environmental information associated with the device is inconsistent with the configured at least one of the expected motion pattern of the device or the expected environmental pattern of the device along the route. The network entity 2002 may also include means for determining, based on the received information from the device, at least one of the device has been compromised or stolen based on the received at least one of the motion information or the environmental information. The network entity 2002 may also include means for generating the at least one of the expected motion pattern or the expected environmental pattern along the route based on received crowdsourced information indicating the at least one of the motion pattern or the environmental pattern along the route. The network entity 2002 may also include means for modifying the at least one of the expected motion pattern or the expected environmental pattern along the route based on machine learning and received second information indicating the at least one of the motion pattern or the environmental pattern experienced by additional devices along the route. The network entity 2002 may also include means for configuring the device with at least one of a public key associated with the server or a private key. The means may be the information component 199 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means.

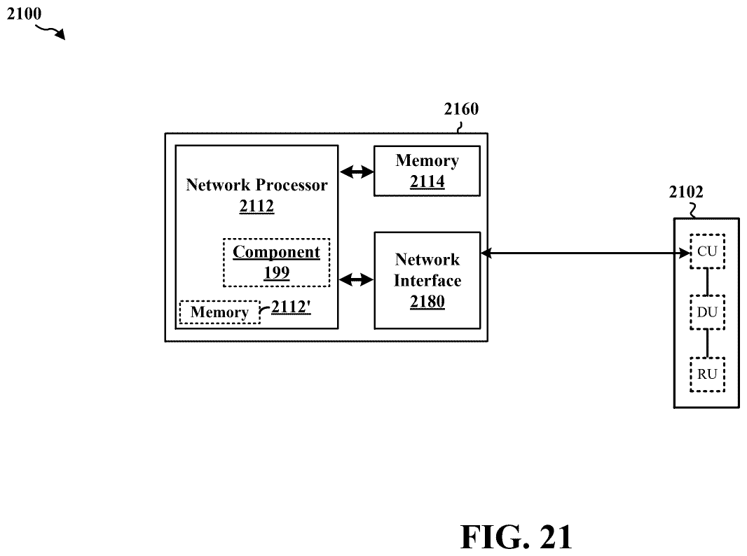

FIG. 21 is a diagram 2100 illustrating an example of a hardware implementation for a network entity 2160. In one example, the network entity 2160 may be within the core network 120. The network entity 2160 may include a network processor 2112. The network processor 2112 may include on-chip memory 2112′. In some aspects, the network entity 2160 may further include additional memory modules 2114. The network entity 2160 communicates via the network interface 2180 directly (e.g., backhaul link) or indirectly (e.g., through a RIC) with the CU 2102. The on-chip memory 2112′ and the additional memory modules 2114 may each be considered a computer-readable medium/memory. Each computer-readable medium/memory may be non-transitory. The processor 2112 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the information component 199 may be configured to configure a device with at least one of an expected motion pattern of the device or an expected environmental pattern of the device along a route. The information component 199 may also be configured to receive, based on the configuration, information from the device indicating that at least one of motion information at the device or environmental information associated with the device is inconsistent with the configured at least one of the expected motion pattern of the device or the expected environmental pattern of the device along the route. The information component 199 may also be configured to determine, based on the received information from the device, at least one of the device has been compromised or stolen based on the received at least one of the motion information or the environmental information. The information component 199 may also be configured to generate the at least one of the expected motion pattern or the expected environmental pattern along the route based on received crowdsourced information indicating the at least one of the motion pattern or the environmental pattern along the route. The information component 199 may also be configured to modify the at least one of the expected motion pattern or the expected environmental pattern along the route based on machine learning and received second information indicating the at least one of the motion pattern or the environmental pattern experienced by additional devices along the route. The information component 199 may also be configured to configure the device with at least one of a public key associated with the server or a private key.

The information component 199 may be within the processor 2112. The information component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2160 may include a variety of components configured for various functions. In one configuration, the network entity 2160 may include means for configuring a device with at least one of an expected motion pattern of the device or an expected environmental pattern of the device along a route. The network entity 2160 may also include means for receiving, based on the configuration, information from the device indicating that at least one of motion information at the device or environmental information associated with the device is inconsistent with the configured at least one of the expected motion pattern of the device or the expected environmental pattern of the device along the route. The network entity 2160 may also include means for determining, based on the received information from the device, at least one of the device has been compromised or stolen based on the received at least one of the motion information or the environmental information. The network entity 2160 may also include means for generating the at least one of the expected motion pattern or the expected environmental pattern along the route based on received crowdsourced information indicating the at least one of the motion pattern or the environmental pattern along the route. The network entity 2160 may also include means for modifying the at least one of the expected motion pattern or the expected environmental pattern along the route based on machine learning and received second information indicating the at least one of the motion pattern or the environmental pattern experienced by additional devices along the route. The network entity 2160 may also include means for configuring the device with at least one of a public key associated with the server or a private key. The means may be the information component 199 of the network entity 2160 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is an apparatus for wireless communication at a device, including a memory and at least one processor coupled to the memory and, based at least in part on information stored in the memory, the at least one processor is configured to: obtain, along a route of the device, at least one of motion information of the device or environmental information associated with the device; and transmit, when the obtained information is inconsistent with at least one of an expected motion pattern of the device or an expected environmental pattern of the device along the route, information indicating that the obtained at least one of the motion information or the environmental information is inconsistent with the at least one of the expected motion pattern of the device or the expected environmental pattern of the device along the route.
Aspect 2 is the apparatus of aspect 1, where the motion information includes at least one of a velocity, acceleration, directional changes, elevation changes, or any combination thereof, and the expected motion pattern includes at least one of an expected velocity pattern, an expected acceleration pattern, an expected directional change pattern, an expected elevation change pattern, or any combination thereof, along the route.
Aspect 3 is the apparatus of any of aspects 1 and 2, where the environmental information includes at least one of a temperature, a humidity, a pressure, one or more detected wireless signals, electromagnetic radiation, an electromagnetic field, or any combination thereof, and the expected environmental pattern includes at least one of an expected temperature pattern, an expected humidity pattern, an expected pressure pattern, an expected detected wireless signal pattern, an expected electromagnetic radiation pattern, an expected electromagnetic field pattern, or any combination thereof, along the route.
Aspect 4 is the apparatus of any of aspects 1 to 3, where the one or more detected wireless signals include one or more wireless signals detected from at least one of an access point, a base station, or a wireless device.
Aspect 5 is the apparatus of any of aspects 1 to 4, where the at least one processor is further configured to: determine, based on a comparison of the obtained information with the at least one of the expected motion pattern of the device or the expected environmental pattern of the device along the route, that the obtained information is inconsistent with the at least one of the expected motion pattern of the device or the expected environmental pattern of the device along the route.
Aspect 6 is the apparatus of any of aspects 1 to 5, where the determination that the obtained information is inconsistent with the at least one of the expected motion pattern of the device or the expected environmental pattern of the device along the route is based on at least one of: a difference between the obtained information and the at least one of the expected motion pattern of the device or the expected environmental pattern of the device along the route being greater than a threshold; or the obtained information being unexpected based on the expected motion pattern of the device or the expected environmental pattern of the device along the route.
Aspect 7 is the apparatus of any of aspects 1 to 6, where the at least one processor is further configured to: obtain, upon the determination that the obtained information is inconsistent with the at least one of the expected motion pattern of the device or the expected environmental pattern of the device along the route, at least one of route deviation information of the device, absolute or relative position information of the device, device information associated with at least one of a detected access point, a detected base station, or a detected wireless device, or any combination thereof, where the transmitted information indicates the at least one of the route deviation information of the device, the absolute or relative position information of the device, the device information associated with the at least one of the detected access point, the detected base station, or the detected wireless device, or any combination thereof.
Aspect 8 is the apparatus of any of aspects 1 to 7, where the transmitted information includes an indication of at least one of: the obtained motion information that is inconsistent with the expected motion pattern along the route; the obtained environmental information that is inconsistent with the expected environmental pattern along the route; a location along the route at which the obtained information is inconsistent with the at least one of the expected motion pattern of the device or the expected environmental pattern of the device; an extrapolated absolute or relative position of the device; images captured by the device; or one or more access points, one or more base stations, or one or more wireless devices detected by the device upon the determination that the obtained information is inconsistent with the at least one of the expected motion pattern of the device or the expected environmental pattern of the device along the route.
Aspect 9 is the apparatus of any of aspects 1 to 8, where the one or more access points, the one or more base stations, or the one or more wireless devices detected by the device are unexpected based on the at least one of the expected motion pattern of the device or the expected environmental pattern of the device along the route.
Aspect 10 is the apparatus of any of aspects 1 to 9, where the information indicating that the obtained at least one of the motion information or the environmental information is inconsistent with the at least one of the expected motion pattern of the device or the expected environmental pattern of the device along the route is transmitted one of: at preconfigured times after the determination that the obtained information is inconsistent with the at least one of the expected motion pattern of the device or the expected environmental pattern of the device along the route; after a preconfigured time or estimated distance traveled upon the determination that the obtained information is inconsistent with the at least one of the expected motion pattern of the device or the expected environmental pattern of the device along the route; or at a time upon successfully connecting to a network.
Aspect 11 is the apparatus of any of aspects 1 to 10, where the determination that the obtained information is inconsistent with the at least one of the expected motion pattern of the device or the expected environmental pattern of the device along the route is based on comparing different types of obtained information during different segments between waypoints along the route with a corresponding expected motion pattern of the device or a corresponding expected environmental pattern of the device.
Aspect 12 is the apparatus of any of aspects 1 to 11, where the at least one processor is further configured to: generate the at least one of the expected motion pattern of the device or the expected environmental pattern of the device for the route based on at least one of motion information of one or more other devices or environmental information associated with the one or more other devices, where the determination that the obtained information is inconsistent with the at least one of the expected motion pattern of the device or the expected environmental pattern of the device along the route is based on the at least one of the motion information of the device or the environmental information associated with the device deviating by a threshold from the at least one of the motion information of the one or more other devices or the environmental information associated with the one or more other devices.
Aspect 13 is the apparatus of any of aspects 1 to 12, where the at least one processor is further configured to: obtain, along the route of the device, at least one of motion information of one or more other devices or environmental information associated with the one or more other devices, where the determination that the obtained information is inconsistent with the at least one of the expected motion pattern of the device or the expected environmental pattern of the device along the route is further based on a comparison between the at least one of the motion information of the device or the environmental information associated with the device and the at least one of the motion information of the one or more other devices or the environmental information associated with the one or more other devices.
Aspect 14 is the apparatus of any of aspects 1 to 13, where the at least one processor is further configured to: transmit, when the obtained information is consistent with at least one of the expected motion pattern of the device or the expected environmental pattern of the device along the route, second information indicating that the obtained at least one of the motion information or the environmental information corresponds with the at least one of the expected motion pattern of the device or the expected environmental pattern of the device along the route.
Aspect 15 is the apparatus of any of aspects 1 to 14, where the at least one processor is further configured to: receive an indication of the at least one of the motion pattern or the environmental pattern expected along the route.
Aspect 16 is the apparatus of any of aspects 1 to 15, where the at least one of the expected motion pattern or the expected environmental pattern includes at least one of a crowdsourced motion pattern or a crowdsourced environmental pattern along the route.
Aspect 17 is the apparatus of any of aspects 1 to 16, where the transmitted information is encrypted based on at least one of a public key or a private key.
Aspect 18 is the apparatus of any of aspects 1 to 17, where the motion information of the device is obtained through at least one of an inertial measurement unit (IMU), a gyroscope, or one or more accelerometers, and where the environmental information associated with the device is obtained through one or more sensors or receivers at the device configured to sense or receive the environmental information.
Aspect 19 is the apparatus of any of aspects 1 to 18, where the at least one processor is further configured to: initiate a wake-up state of the device when the obtained at least one of the motion information or the environmental information is consistent with the at least one of the expected motion pattern of the device or the expected environmental pattern of the device along the route; and transmit, during the wake-up state of the device, an indication of at least one of: (1) one or more access points, one or more base stations, or one or more wireless devices along the route, or (2) the device passed one or more predefined locations along the route.
Aspect 20 is an apparatus for wireless communication at a server (e.g., a cloud server, a third party server, an edge server, a network, or a network entity), including a memory and at least one processor coupled to the memory and, based at least in part on information stored in the memory, the at least one processor is configured to: configure a device with at least one of an expected motion pattern of the device or an expected environmental pattern of the device along a route; and receive, based on the configuration, information from the device indicating that at least one of motion information at the device or environmental information associated with the device is inconsistent with the configured at least one of the expected motion pattern of the device or the expected environmental pattern of the device along the route.
Aspect 21 is the apparatus of aspect 20, where the at least one processor is further configured to: determine, based on the received information from the device, at least one of the device has been compromised or stolen based on the received at least one of the motion information or the environmental information.
Aspect 22 is the apparatus of any of aspects 20 to 21, where the motion information includes at least one of a velocity, acceleration, directional changes, or elevation changes at the device, and the expected motion pattern includes at least one of an expected velocity pattern, an expected acceleration pattern, an expected directional change pattern, an expected elevation change pattern, or any combination thereof, at the device along the route.
Aspect 23 is the apparatus of any of aspects 20 to 22, where the environmental information associated with the device includes at least one of a temperature, a humidity, a pressure, one or more detected wireless signals, electromagnetic radiation, an electromagnetic field at the device, or any combination thereof, and the expected environmental pattern includes at least one of an expected temperature pattern, an expected humidity pattern, an expected pressure pattern, an expected detected wireless signal pattern, an expected electromagnetic radiation pattern, an expected electromagnetic field pattern, or any combination thereof, at the device along the route.
Aspect 24 is the apparatus of any of aspects 20 to 23, where the received information indicates at least one of route deviation information of the device from the route, absolute or relative position information of the device, device information associated with at least one of a detected access point, base station, or wireless device, or any combination thereof.
Aspect 25 is the apparatus of any of aspects 20 to 24, where the received information includes an indication of at least one of: the motion information that is inconsistent with the expected motion pattern along the route; the environmental information that is inconsistent with the expected environmental pattern along the route; a location along the route at which the at least one of the motion information or the environmental information is inconsistent with the at least one of the expected motion pattern of the device or the expected environmental pattern of the device; an extrapolated absolute or relative position of the device; images captured by the device; or one or more access points, base stations, or wireless devices detected by the device.
Aspect 26 is the apparatus of any of aspects 20 to 25, where the at least one processor is further configured to: generate the at least one of the expected motion pattern or the expected environmental pattern along the route based on received crowdsourced information indicating the at least one of the motion pattern or the environmental pattern along the route.
Aspect 27 is the apparatus of any of aspects 20 to 26, where the at least one processor is further configured to: modify the at least one of the expected motion pattern or the expected environmental pattern along the route based on machine learning and received second information indicating the at least one of the motion pattern or the environmental pattern experienced by additional devices along the route.
Aspect 28 is the apparatus of any of aspects 20 to 27, where the configured at least one of the expected motion pattern of the device or the expected environmental pattern of the device along the route indicates different types of motion information or different types of environmental information that should be obtained by the device during different segments between waypoints along the route for comparison with the expected motion pattern of the device or the expected environmental pattern of the device.
Aspect 29 is the apparatus of any of aspects 20 to 28, where the at least one processor is further configured to: configure the device with at least one of a public key associated with the server or a private key, where the received information is encrypted based on at least one of the public key or the private key.
Aspect 30 is the apparatus of any of aspects 1 to 29, where the apparatus is a wireless communication device, further including at least one of an antenna or a transceiver coupled to the at least one processor.
Aspect 31 is a method of wireless communication for implementing any of aspects 1 to 30.
Aspect 32 is an apparatus for wireless communication including means for implementing any of aspects 1 to 30.
Aspect 33 is a computer-readable medium (e.g., a non-transitory computer-readable medium) storing computer executable code, the code when executed by at least one processor causes the at least one processor to implement any of aspects 1 to 30.

What is claimed is:

1. An apparatus for wireless communication at a device, comprising:
a memory; and
at least one processor coupled to the memory and, based at least in part on first information stored in the memory, the at least one processor is configured to:
obtain, along a route of the device, at least one of motion information of the device or environmental information associated with the device; and
transmit, when the obtained information is inconsistent with at least one of an expected motion pattern of the device or an expected environmental pattern of the device along the route, information indicating that the obtained at least one of the motion information or the environmental information is inconsistent with the at least one of the expected motion pattern of the device or the expected environmental pattern of the device along the route.

2. The apparatus of claim 1, wherein the motion information comprises at least one of a velocity, acceleration, directional changes, elevation changes, or any combination thereof, and the expected motion pattern comprises at least one of an expected velocity pattern, an expected acceleration pattern, an expected directional change pattern, an expected elevation change pattern, or any combination thereof, along the route.

3. The apparatus of claim 1, wherein the environmental information comprises at least one of a temperature, a humidity, a pressure, one or more detected wireless signals, electromagnetic radiation, an electromagnetic field, or any combination thereof, and the expected environmental pattern comprises at least one of an expected temperature pattern, an expected humidity pattern, an expected pressure pattern, an expected detected wireless signal pattern, an expected electromagnetic radiation pattern, an expected electromagnetic field pattern, or any combination thereof, along the route.

4. The apparatus of claim 3, wherein the one or more detected wireless signals comprise one or more wireless signals detected from at least one of an access point, a base station, or a wireless device.

5. The apparatus of claim 1, wherein the at least one processor is further configured to:
determine, based on a comparison of the obtained information with the at least one of the expected motion pattern of the device or the expected environmental pattern of the device along the route, that the obtained information is inconsistent with the at least one of the expected motion pattern of the device or the expected environmental pattern of the device along the route.

6. The apparatus of claim 5, wherein the determination that the obtained information is inconsistent with the at least one of the expected motion pattern of the device or the expected environmental pattern of the device along the route is based on at least one of:
a difference between the obtained information and the at least one of the expected motion pattern of the device or the expected environmental pattern of the device along the route being greater than a threshold; or
the obtained information being unexpected based on the expected motion pattern of the device or the expected environmental pattern of the device along the route.

7. The apparatus of claim 5, wherein the at least one processor is further configured to:
obtain, upon the determination that the obtained information is inconsistent with the at least one of the expected motion pattern of the device or the expected environmental pattern of the device along the route, at least one of route deviation information of the device, absolute or relative position information of the device, device information associated with at least one of a detected access point, a detected base station, or a detected wireless device, or any combination thereof,
wherein the transmitted information indicates the at least one of the route deviation information of the device, the absolute or relative position information of the device, the device information associated with the at least one of the detected access point, the detected base station, or the detected wireless device, or any combination thereof.

8. The apparatus of claim 5, wherein the transmitted information comprises an indication of at least one of:
the obtained motion information that is inconsistent with the expected motion pattern along the route;
the obtained environmental information that is inconsistent with the expected environmental pattern along the route;
a location along the route at which the obtained information is inconsistent with the at least one of the expected motion pattern of the device or the expected environmental pattern of the device;
an extrapolated absolute or relative position of the device;
images captured by the device; or
one or more access points, one or more base stations, or one or more wireless devices detected by the device upon the determination that the obtained information is inconsistent with the at least one of the expected motion pattern of the device or the expected environmental pattern of the device along the route.

9. The apparatus of claim 8, wherein the one or more access points, the one or more base stations, or the one or more wireless devices detected by the device are unexpected based on the at least one of the expected motion pattern of the device or the expected environmental pattern of the device along the route.

10. The apparatus of claim 5, wherein the information indicating that the obtained at least one of the motion information or the environmental information is inconsistent with the at least one of the expected motion pattern of the device or the expected environmental pattern of the device along the route is transmitted one of:
at preconfigured times after the determination that the obtained information is inconsistent with the at least one of the expected motion pattern of the device or the expected environmental pattern of the device along the route;
after a preconfigured time or estimated distance traveled upon the determination that the obtained information is inconsistent with the at least one of the expected motion pattern of the device or the expected environmental pattern of the device along the route; or
at a time upon successfully connecting to a network.

11. The apparatus of claim 5, wherein the determination that the obtained information is inconsistent with the at least one of the expected motion pattern of the device or the expected environmental pattern of the device along the route is based on comparing different types of obtained information during different segments between waypoints along the route with a corresponding expected motion pattern of the device or a corresponding expected environmental pattern of the device.

12. The apparatus of claim 5, wherein the at least one processor is further configured to:
generate the at least one of the expected motion pattern of the device or the expected environmental pattern of the device for the route based on at least one of motion information of one or more other devices or environmental information associated with the one or more other devices, wherein the determination that the obtained information is inconsistent with the at least one of the expected motion pattern of the device or the expected environmental pattern of the device along the route is based on the at least one of the motion information of the device or the environmental information associated with the device deviating by a threshold from the at least one of the motion information of the one or more other devices or the environmental information associated with the one or more other devices.

13. The apparatus of claim 5, wherein the at least one processor is further configured to:
obtain, along the route of the device, at least one of motion information of one or more other devices or environmental information associated with the one or more other devices, wherein the determination that the obtained information is inconsistent with the at least one of the expected motion pattern of the device or the expected environmental pattern of the device along the route is further based on a comparison between the at least one of the motion information of the device or the environmental information associated with the device and the at least one of the motion information of the one or more other devices or the environmental information associated with the one or more other devices.

14. The apparatus of claim 1, wherein the at least one processor is further configured to:
transmit, when the obtained information is consistent with at least one of the expected motion pattern of the device or the expected environmental pattern of the device along the route, second information indicating that the obtained at least one of the motion information or the environmental information corresponds with the at least one of the expected motion pattern of the device or the expected environmental pattern of the device along the route.

15. The apparatus of claim 1, wherein the at least one processor is further configured to:
receive an indication of the at least one of the motion pattern or the environmental pattern expected along the route.

16. The apparatus of claim 15, wherein the at least one of the expected motion pattern or the expected environmental pattern comprises at least one of a crowdsourced motion pattern or a crowdsourced environmental pattern along the route.

17. The apparatus of claim 1, wherein the transmitted information is encrypted based on at least one of a public key or a private key.

18. The apparatus of claim 1, wherein the motion information of the device is obtained through at least one of an inertial measurement unit (IMU), a gyroscope, or one or more accelerometers, and wherein the environmental information associated with the device is obtained through one or more sensors or receivers at the device configured to sense or receive the environmental information.

19. The apparatus of claim 1, wherein the at least one processor is further configured to:
initiate a wake-up state of the device when the obtained at least one of the motion information or the environmental information is consistent with the at least one of the expected motion pattern of the device or the expected environmental pattern of the device along the route; and
transmit, during the wake-up state of the device, an indication of at least one of: (1) one or more access points, one or more base stations, or one or more wireless devices along the route, or (2) the device passed one or more predefined locations along the route.

20. An apparatus for wireless communication at a server, comprising:
a memory; and
at least one processor coupled to the memory and, based at least in part on first information stored in the memory, the at least one processor is configured to:
configure a device with at least one of an expected motion pattern of the device or an expected environmental pattern of the device along a route; and
receive, based on the configuration, information from the device indicating that at least one of motion information at the device or environmental information associated with the device is inconsistent with the configured at least one of the expected motion pattern of the device or the expected environmental pattern of the device along the route.

21. The apparatus of claim 20, wherein the at least one processor is further configured to:
determine, based on the received information from the device, at least one of the device has been compromised or stolen based on the received at least one of the motion information or the environmental information.

22. The apparatus of claim 20, wherein the motion information comprises at least one of a velocity, acceleration, directional changes, or elevation changes at the device, and the expected motion pattern comprises at least one of an expected velocity pattern, an expected acceleration pattern, an expected directional change pattern, an expected elevation change pattern, or any combination thereof, at the device along the route.

23. The apparatus of claim 20, wherein the environmental information associated with the device comprises at least one of a temperature, a humidity, a pressure, one or more detected wireless signals, electromagnetic radiation, an electromagnetic field at the device, or any combination thereof, and the expected environmental pattern comprises at least one of an expected temperature pattern, an expected humidity pattern, an expected pressure pattern, an expected detected wireless signal pattern, an expected electromagnetic radiation pattern, an expected electromagnetic field pattern, or any combination thereof, at the device along the route.

24. The apparatus of claim 20, wherein the received information indicates at least one of route deviation information of the device from the route, absolute or relative position information of the device, device information associated with at least one of a detected access point, base station, or wireless device, or any combination thereof.

25. The apparatus of claim 20, wherein the received information comprises an indication of at least one of:
the motion information that is inconsistent with the expected motion pattern along the route;
the environmental information that is inconsistent with the expected environmental pattern along the route;
a location along the route at which the at least one of the motion information or the environmental information is inconsistent with the at least one of the expected motion pattern of the device or the expected environmental pattern of the device;
an extrapolated absolute or relative position of the device;
images captured by the device; or
one or more access points, base stations, or wireless devices detected by the device.

26. The apparatus of claim 20, wherein the at least one processor is further configured to:
generate the at least one of the expected motion pattern or the expected environmental pattern along the route based on received crowdsourced information indicating the at least one of the motion pattern or the environmental pattern along the route.

27. The apparatus of claim 20, wherein the at least one processor is further configured to:
modify the at least one of the expected motion pattern or the expected environmental pattern along the route based on machine learning and received second information indicating the at least one of the motion pattern or the environmental pattern experienced by additional devices along the route.

28. The apparatus of claim 20, wherein the at least one processor is further configured to:
configure the device with at least one of a public key associated with the server or a private key, wherein the received information is encrypted based on at least one of the public key or the private key;
wherein the configured at least one of the expected motion pattern of the device or the expected environmental pattern of the device along the route indicates different types of motion information or different types of environmental information that should be obtained by the device during different segments between waypoints along the route for comparison with the expected motion pattern of the device or the expected environmental pattern of the device.

29. A method of wireless communication at a device, comprising:
obtaining, along a route of the device, at least one of motion information of the device or environmental information associated with the device; and
transmitting, when the obtained information is inconsistent with at least one of an expected motion pattern of the device or an expected environmental pattern of the device along the route, information indicating that the obtained at least one of the motion information or the environmental information is inconsistent with the at least one of the expected motion pattern of the device or the expected environmental pattern of the device along the route.

30. A method of wireless communication at a server, comprising:
configuring a device with at least one of an expected motion pattern of the device or an expected environmental pattern of the device along a route; and
receiving, based on the configuration, information from the device indicating that at least one of motion information at the device or environmental information associated with the device is inconsistent with the configured at least one of the expected motion pattern of the device or the expected environmental pattern of the device along the route.
